(19) United States
(12) Patent Application Publication
(10) Pub. No.: US 2023/0048481 A1
(43) Pub. Date: Feb. 16, 2023

(54) SYSTEMS AND METHODS FOR AI INFERENCE PLATFORM

(71) Applicant: Palantir Technologies Inc., Palo Alto, CA (US)

(72) Inventors: Andrew Elder, Greenwood Village, CO (US); Anand Gupta, Snowmass Village, CO (US); Daniel Cervelli, Wanaka (NZ); Robert Imig, Washington, DC (US); Tess Druckenmiller, Brooklyn, NY (US)

(21) Appl. No.: 17/884,760

(22) Filed: Aug. 10, 2022

Related U.S. Application Data
(60) Provisional application No. 63/232,062, filed on Aug. 11, 2021.

(51) Int. Cl. G06N 20/20; G06F 9/38

(52) U.S. Cl. CPC G06N 20/20; G06F 9/3867

(57) ABSTRACT

System and method for using and managing artificial intelligence (AI) inference platform (AIP) and/or model orchestrators according to certain embodiments. For example, a method includes receiving sensor data via a data interface of a model orchestrator, the model orchestrator including an indication of a model pipeline, the model pipeline including a plurality of models; loading the plurality of models according to the model pipeline; applying the model pipeline to the received sensor data; receiving a model output from the model pipeline via a model interface of the model orchestrator; and generating an insight based at least in part on the model output.

### CROSS REFERENCE TO RELATED APPLICATIONS

This application claims priority to U.S. Provisional Application No. 63/232,062, filed Aug. 11, 2021, incorporated by reference herein for all purposes.

### TECHNICAL FIELD

Certain embodiments of the present disclosure are directed to systems and methods for using artificial intelligence (AI) models and other computational models. More particularly, some embodiments of the present disclosure provide systems and methods for model orchestrations.

### BACKGROUND

Artificial intelligence (AI) is widely used in analyzing data to facilitate object detection, prediction, decision making, and other uses. For example, AI inference is a process of using AI models to make a prediction. AI inference often needs a large number of computing resources and memory resources.

Hence it is desirable to improve the techniques for AI inference.

### SUMMARY

Certain embodiments of the present disclosure are directed to systems and methods for using artificial intelligence models and other computational models. More particularly, some embodiments of the present disclosure provide systems and methods for model orchestrations.

In some embodiments, a method for using one or more model orchestrators, the method includes the steps of: receiving sensor data via a data interface of one model orchestrator of the one or more model orchestrators, the one model orchestrator including an indication of a model pipeline, the model pipeline including a plurality of models; loading the plurality of models according to the model pipeline; applying the model pipeline to the received sensor data; receiving a model output from the model pipeline via a model interface of the one model orchestrator; and generating an insight based at least in part on the model output, the insight is smaller than the sensor data in data size; wherein the method is performed using one or more processors.

In certain embodiments, a method for managing one or more model orchestrators, the method includes the steps of: receiving historical data; selecting one or more models based at least in part on a data characteristic, a processing characteristic, or the historical data; developing a model pipeline including the one or more models, one model orchestrator of the one or more model orchestrators including an indication of the model pipeline; generate a data interface for the one model orchestrator interface with real-time sensor data; generate a model interface for the one model orchestrator to interface with the model pipeline; and deploy the one model orchestrator; wherein the method is performed using one or more processors.

In some embodiments, a system for using one or more model orchestrators, the system includes: one or more memories comprising instructions stored thereon; and one or more processors configured to execute the instructions and perform operations comprising: receiving sensor data via a data interface of one model orchestrator of the one or more model orchestrators, the one model orchestrator including an indication of a model pipeline, the model pipeline including a plurality of models; loading the plurality of models according to the model pipeline; applying the model pipeline to the received sensor data; receiving a model output from the model pipeline via a model interface of the one model orchestrator; and generating an insight based at least in part on the model output, the insight is smaller than the sensor data in data size.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 illustrates AIP in a deployment environment according to some embodiments of the present disclosure.

FIG. 2 illustrates AIP in a deployment environment according to certain embodiments of the present disclosure.

FIG. 3 illustrates AIP in a deployment environment according to certain embodiments of the present disclosure.

FIG. 4 is an illustrative AIP diagram according to certain embodiments of the present disclosure.

FIG. 5 is an example AIP architecture diagram in accordance with certain embodiments of the present disclosure.

FIG. 6 is an illustrative an AIP architecture (e.g., an AIP and DMP architecture) diagram according to certain embodiments of the present disclosure.

FIG. 7 is an illustrative AIP system according to certain embodiments of the present disclosure.

FIG. 8 is an illustrative AIP system according to certain embodiments of the present disclosure.

FIG. 9 is an illustrative AIP system according to certain embodiments of the present disclosure.

FIG. 10 is an illustrative AIP system according to certain embodiments of the present disclosure.

FIG. 11 is an illustrative flow diagram for an AIP system according to certain embodiments of the present disclosure.

FIG. 12 is an illustrative example of an AIP system according to certain embodiments of the present disclosure.

FIG. 13 is an illustrative example of features of an AIP system according to certain embodiments of the present disclosure.

FIG. 14 is an illustrative diagram of an AIP system according to certain embodiments of the present disclosure.

FIG. 15 is an illustrative comparison of a conventional system and an AIP system according to certain embodiments of the present disclosure.

FIG. 16 is an illustrative example deployment environment according to certain embodiments of the present disclosure.

FIG. 17 is an illustrative example of an AIP deployment environment according to certain embodiments of the present disclosure.

FIG. 18 is an illustrative AIP diagram according to certain embodiments of the present disclosure.

FIGS. 19-26 are example AIP systems for various use cases according to certain embodiments of the present disclosure.

FIG. 27 is an illustrative graphical user interface (GUI) for an AIP system according to certain embodiments of the present disclosure.

FIG. 28 is a simplified diagram showing a method for AIP development according to certain embodiments of the present disclosure.

FIG. 29 is a simplified diagram showing a method for AIP use according to certain embodiments of the present disclosure.

FIG. 30 is a simplified diagram showing a computing system for implementing a system for AIP according to one embodiment of the present disclosure.

### DETAILED DESCRIPTION

Unless otherwise indicated, all numbers expressing feature sizes, amounts, and physical properties used in the specification and claims are to be understood as being modified in all instances by the term “about” according to some embodiments. Accordingly, for example, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

Although illustrative methods may be represented by one or more drawings (e.g., flow diagrams, communication flows, etc.), the drawings should not be interpreted as implying any requirement of, or particular order among or between, various steps disclosed herein according to certain embodiments. However, some embodiments may require certain steps and/or certain orders between certain steps, as may be explicitly described herein and/or as may be understood from the nature of the steps themselves (e.g., the performance of some steps may depend on the outcome of a previous step). Additionally, for example, a “set,” “subset,” or “group” of items (e.g., inputs, algorithms, data values, etc.) may include one or more items and, similarly, a subset or subgroup of items may include one or more items. A “plurality” means more than one.

As used herein, the term “based on” is not meant to be restrictive, but rather indicates that a determination, identification, prediction, calculation, and/or the like, is performed by using, at least, the term following “based on” as an input according to some embodiments. As an example, predicting an outcome based on a particular piece of information may additionally, or alternatively, base the same determination on another piece of information. As used herein, for example, the term “receive” or “receiving” means obtaining from a data repository (e.g., database), from another system or service, from another software, or from another software component in a same software. In certain embodiments, the term “access” or “accessing” means retrieving data or information, and/or generating data or information.

According to certain embodiments, AI Inference Platform (AIP) orchestrates between the input sensor data and output feeds. As an example, AIP is a model orchestrator. For example, the input and/or output (e.g., “left side, “right” sides) of AIP are utilizing open standard formats. As an example, AIP takes care of the decoding of the input data, orchestration between processors and artificial intelligence (AI) models, and then packages up the results into an open output format for downstream consumers.

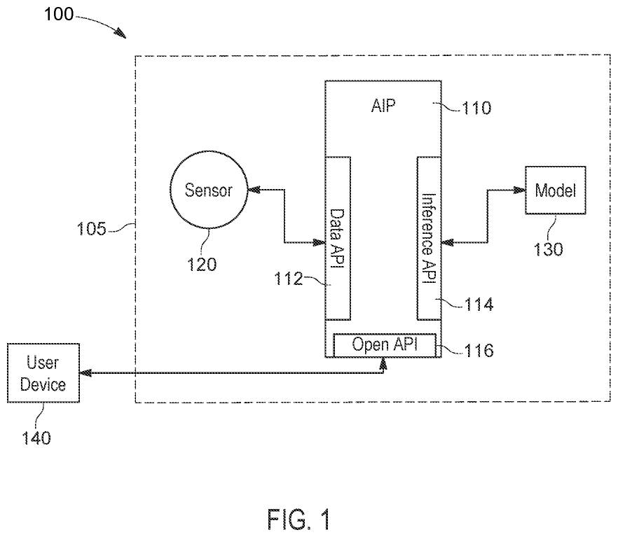

FIG. 1 illustrates AIP in a deployment environment 100 according to some embodiments of the present disclosure. FIG. 1 is merely an example. One of ordinary skill in the art would recognize many variations, alternatives, and modifications.

According to certain embodiments, the deployment environment 100 includes an AIP 110 (e.g., a model orchestrator), a sensor 120, a model 130, and a user device 140. In some examples, the AIP 110 includes a data API 112, an inference API 114, and an open API 116. Although the above has been shown using a selected group of components for the AIP 110, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

In certain examples, the data API 112 is configured to interface with the sensor 120. In some examples, the data API 112 includes a specific data format (e.g., a predefined data format) or data stream format (e.g., a predefined data packet format) for a type of sensor. As an example, the data API 112 includes a first data format for a first sensor type (e.g., an image sensor) and a second data format for a second sensor type (e.g., a motion sensor), where the first data format is different from the second data format. For example, the data API 112 is configured to receive various sensor feeds. As an example, the data API 112 is configured to receive a sensor feed with data format information.

In certain examples, the AIP 110 is configured to receive sensor data via the data API 112. In some examples, the AIP 110 is configured to process the received sensor data received from the data API 112. In certain examples, the AIP 110 includes one or more models, computing units, and/or storage units. As used herein, a model, or referred to as a computing model, includes a model to process data. A model includes, for example, an AI model, a machine learning (ML) model, a deep learning (DL) model, an image processing model, other computing models, and/or a combination thereof. For example, the AIP 110 is configured to decode the sensor data. As an example, the AIP 110 is configured to extract a single frame from video data. For example, the AIP 110 includes one or more AI models to recognize objects or patterns in the sensor data. As an example, the AIP 110 is configured to combine data.

In some examples, the inference API 114 is configured to be coupled to the model 130. In certain examples, the inference API 114 includes a predetermined interface to couple to the model 130. In some examples, the inference API 114 includes a dynamically configurable interface to couple to the model 130.

In certain examples, the inference API 114 is configured to couple to the model 130 based upon a configuration (e.g., a system configuration, a user configuration) and/or an input (e.g., a user input, an input received via a software interface). In some examples, the inference API 114 is configured to couple to the model 130 automatically or dynamically based on the processed sensor data. In certain examples, the AIP 110 is configured to transmit processed sensor data to the model 130 via the inference API 114.

According to some embodiments, the AIP 110 is configured to change the model 130 coupled via the inference API 114 dynamically. In certain examples, the AIP 110 is configured to change the model 130 based upon a configuration (e.g., a system configuration, a user configuration) and/or an input (e.g., a user input, an input received via a software interface). In some examples, the AIP 110 is configured to change the model 130 automatically or dynamically based on the processed sensor data. As an example, the AIP 110 is configured to change the model 130 in response to changes to the sensor data collected via the sensor 120. In certain examples, the AIP 110 is configured to change the model 130 without affecting the connection to the sensor 120. In some examples, the AIP 110 is configured to upgrade the model 130 without affecting the connection to the sensor 120. In certain examples, the AIP 110 is configured to replace the model 130 with a new model without affecting the connection to the sensor 120. In some examples, the model 130 is changed, upgraded, and/or replaced by a push operation in the deployment environment 100.

According to certain embodiments, the AIP 110 is configured to change the sensor 120 coupled via the data API 112 dynamically. In certain examples, the AIP 110 is configured to change sensor 120 based upon a configuration (e.g., a system configuration, a user configuration) and/or an input (e.g., a user input, an input received via a software interface). In some examples, the AIP 110 is configured to change the sensor 120 or add a coupled sensor automatically or dynamically, for example, based on a command received via a software interface.

According to some embodiments, the AIP 110, the sensor 120, and the model 130 are disposed in an edge device 105. For example, the edge device 105 is a satellite or a computing device integrated with or disposed on a satellite, and the sensor 120 is an orbiting sensor. As an example, an edge device is an aircraft, a submarine, and/or a vehicle. As an example, an edge device includes one or more sensors in the air, in the space, under the sea, in the water, on the land, and/or at other locations. In certain examples, an edge device is a physical device including one or more sensors, an AIP, and/or one or more model(s). In some examples, the model 130 is configured to generate an insight based on the processed sensor data. As user herein, an insight refers to an output of a computing model. In certain examples, the open API 116 is configured to couple to the user device 140. In some examples, the AIP 110 is configured to transmit collected sensor data, processed sensor data, and/or the insight to the user device 140.

As discussed above and further emphasized here, FIG. 1 is merely an example. One of ordinary skill in the art would recognize many variations, alternatives, and modifications. For example, the sensor 120 is replaced by a sub-system that includes one or more components that are not sensors. As an example, the model 130 is a micro-model. As used herein, a micro-model is an operation-specific model. In some embodiments, a micro-model is small and/or modular model. In certain embodiments, a micro-model focuses on small and/or very specific pieces of data.

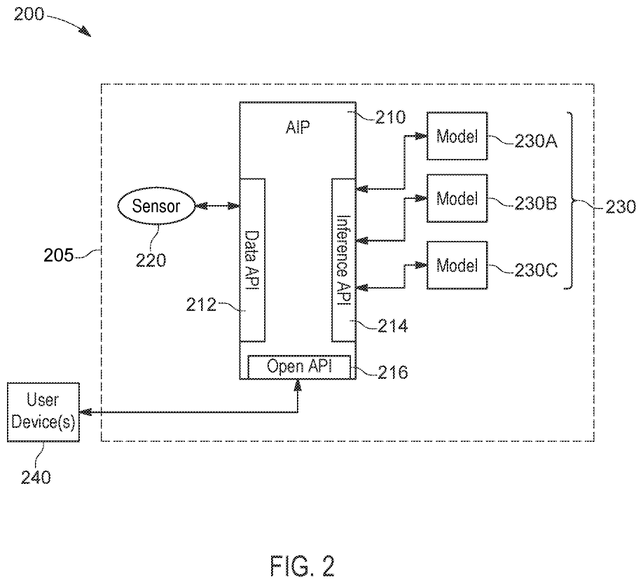

FIG. 2 illustrates AIP in a deployment environment 200 according to certain embodiments of the present disclosure. FIG. 2 is merely an example. One of ordinary skill in the art would recognize many variations, alternatives, and modifications.

According to certain embodiments, the deployment environment 200 includes an AIP 210 (e.g., a model orchestrator), a sensor 220, a plurality of models 230, and one or more user devices 240. In some examples, the AIP 210 includes a data API 212, an inference API 214, and an open API 216. Although the above has been shown using a selected group of components for the AIP 210, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

In certain examples, the data API 212 is configured to interface with the sensor 220. In some examples, the data API 212 includes a specific data format (e.g., a predefined data format) or data stream format (e.g., a predefined data packet format) for a type of sensor. As an example, the data API 212 includes a first data format for a first sensor type (e.g., an image sensor) and a second data format for a second sensor type (e.g., a motion sensor), where the first data format is different from the second data format. For example, the data API 212 is configured to receive various sensor feeds. As an example, the data API 212 is configured to receive a sensor feed with data format information.

In certain examples, the AIP 210 is configured to receive sensor data via the data API 212. In some examples, the AIP 210 is configured to process the received sensor data received from the data API 212. In certain examples, the AIP 210 includes one or more models, computing units, and/or storage units. For example, the AIP 210 is configured to decode the sensor data. As an example, the AIP 210 is configured to extract a single frame from video data. For example, the AIP 210 includes one or more AI models to recognize objects or patterns in the sensor data.

In some examples, the inference API 214 is configured to be coupled to the models 230. For example, the models 230 includes models 230A, 230B, and 230C. A model includes, for example, an AI model, a machine learning (ML) model, a deep learning (DL) model, an image processing model, other computing models, and/or a combination thereof. In certain examples, the inference API 214 includes a predetermined interface to couple to one of the models 230. In some examples, the inference API 214 includes a dynamically configurable interface to couple to one of the models 230.

In certain examples, the inference API 214 is configured to couple to one of the models 230 based upon a configuration (e.g., a system configuration, a user configuration) and/or an input (e.g., a user input, an input received via a software interface). In some examples, the inference API 214 is configured to couple to the model 230 automatically or dynamically based on the processed sensor data. In certain examples, the AIP 210 is configured to transmit processed sensor data to one of the models 230 via the inference API 214.

According to some embodiments, the AIP 210 is configured to select and use one or more models 230 dynamically. In certain examples, the AIP 210 is configured to change the models 230 based upon a configuration (e.g., a system configuration, a user configuration) and/or an input (e.g., a user input, an input received via a software interface). In some examples, the AIP 210 is configured to select and use one or more models 230 automatically or dynamically based on the processed sensor data. In certain examples, the AIP 210 is configured to change the selected model 230 without affecting the connection to the sensor 220. In some examples, the AIP 210 is configured to upgrade the selected model 230 without affecting the connection to the sensor 220. In certain examples, the AIP 210 is configured to add a new model to the one or more models 230 with a new model without affecting the connection to the sensor 220. In some examples, the AIP 210 is configured to delete a model from the one or more models 230 without affecting the connection to the sensor 220. In certain examples, one or more models 230 are updated, upgraded, added, deleted, and/or replaced by a push operation in the deployment environment 200.

According to some embodiments, AIP 210 is configured to change the one or more selected models 230 dynamically during the deployment environment (e.g., hot swap), without interrupting the operation. As an example, the AIP 210 is configured to couple the sensor 220 to the model 230A. In such example, during the operation, the AIP 210 selects the model 230B and changes the coupling of the sensor 220 to the model 230B. In certain examples, AIP 210 is configured to couple sensor data from the sensor 220 to one or more models 230. As an example, AIP 210 is configured to couple sensor data (e.g., collected data, processed data) to both the model 230A and 230B. For example, the sensor 220 is an image sensor to collect videos, AIP 210 is configured to couple the sensor data collected from the sensor 220 to the model 230A when the sensor 220 takes videos in the air (e.g., wildfire videos) and AIP 210 is configured to couple the sensor data collected from the sensor 220 to the model 230C when the sensor 220 takes videos in the water (e.g., sea creature videos).

According to certain embodiments, the AIP 210, the sensor 220, and/or one or more models 230 are disposed in an edge device 205. For example, the edge device 205 is a satellite, and the sensor 220 is an orbiting sensor. As an example, an edge device is a device disposed on or integrated with an aircraft, a submarine, and/or a vehicle. As an example, an edge device includes one or more sensors in the air, in the space, under the sea, in the water, on the land, and/or at other locations. According to some embodiments, the selected model(s) 230 is configured to generate an insight based on the processed sensor data. In some examples, the open API 216 is configured to couple to one or more user devices 240. In certain examples, the AIP 210 is configured to transmit collected sensor data, processed sensor data, and/or one or more insights to the user device 240.

As discussed above and further emphasized here, FIG. 2 is merely an example. One of ordinary skill in the art would recognize many variations, alternatives, and modifications. For example, the sensor 220 is replaced by a sub-system that includes one or more components that are not sensors. As an example, at least one model of the one or more models 230 is a micro-model.

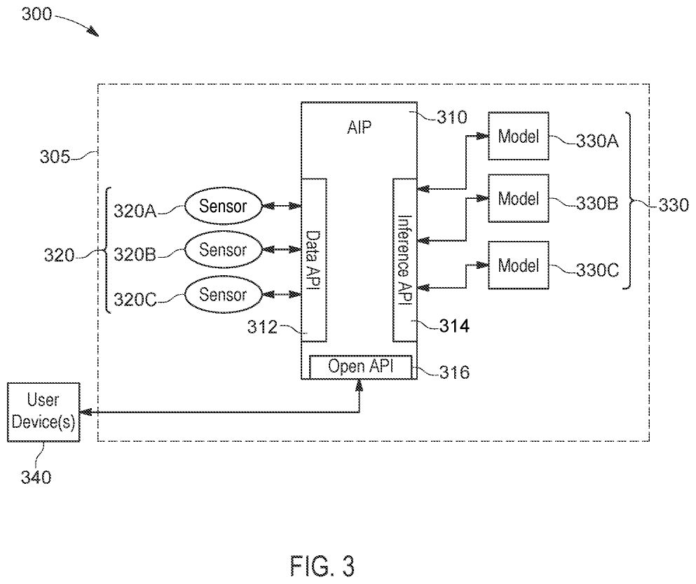

FIG. 3 illustrates AIP in a deployment environment 300 according to certain embodiments of the present disclosure. FIG. 3 is merely an example. One of ordinary skill in the art would recognize many variations, alternatives, and modifications. According to certain embodiments, the deployment environment 300 includes one or more AIPs 310 (e.g., one or more model orchestrators), a plurality of sensors 320, a plurality of models 330, and one or more user devices 340. In some examples, the AIP 310 includes a data API 312, an inference API 314, and an open API 316. Although the above has been shown using a selected group of components for the AIP 310, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

For example, the sensors 320 includes sensors 320A, 320B, and 320C. While the example in FIG. 3 shows three sensors, a deployment environment may include more than three sensors (e.g., tens of sensors, hundreds of sensors, etc.) or less than three sensors. In certain examples, the data API 312 is configured to interface with the sensors 320. In some examples, the data API 312 includes a specific data format (e.g., a predefined data format) or data stream format (e.g., a predefined data packet format) for a type of sensor. As an example, the data API 312 includes a first data format for a first sensor type (e.g., an image sensor) and a second data format for a second sensor type (e.g., a motion sensor), where the first data format is different from the second data format. For example, the data API 312 is configured to receive various sensor feeds. As an example, the data API 312 is configured to receive a sensor feed with data format information.

In certain examples, the AIP 310 is configured to receive sensor data via the data API 312. In some examples, the AIP 310 is configured to process the received sensor data received from the data API 312. In certain examples, the AIP 310 includes one or more models, computing units, and/or storage units. For example, the AIP 310 is configured to decode the sensor data. As an example, the AIP 310 is configured to extract a single frame from video data. For example, the AIP 310 includes one or more AI models to recognize objects or patterns in the sensor data.

In some examples, the inference API 314 is configured to be coupled to the models 330. For example, the models 330 includes models 330A, 330B, and 330C. A model includes, for example, an AI model, a machine learning (ML) model, a deep learning (DL) model, an image processing model, other computing models, and/or a combination thereof. In certain examples, the inference API 314 includes a predetermined interface to couple to one of the models 330. In some examples, the inference API 314 includes a dynamically configurable interface to couple to one of the models 330.

In certain examples, the inference API 314 is configured to couple to one of the models 330 based upon a configuration (e.g., a system configuration, a user configuration) and/or an input (e.g., a user input, an input received via a software interface). In some examples, the inference API 314 is configured to couple to one or more of the plurality of models 330 automatically or dynamically based on the processed sensor data. In certain examples, the AIP 310 is configured to transmit processed sensor data to one of the models 330 via the inference API 314.

According to some embodiments, the AIP 310 is configured to select and use one or more models 330 dynamically. In certain examples, the AIP 310 is configured to change the one or more models 330 based upon a configuration (e.g., a system configuration, a user configuration) and/or an input (e.g., a user input, an input received via a software interface). In some examples, the AIP 310 is configured to select and use one or more models 330 automatically or dynamically based on the processed sensor data. In certain examples, the AIP 310 is configured to change the selected model 330 without affecting the connection to the sensors 320. In some examples, the AIP 310 is configured to upgrade one or more selected models 330 without affecting the connection to the sensors 320. In certain examples, the AIP 310 is configured to add a new model to the one or more models 330 with a new model without affecting the connection to the sensors 320. In some examples, the AIP 310 is configured to delete a model from the one or more models 330 without affecting the connection to the sensors 320. In certain examples, one or more models 330 are updated, upgraded, added, deleted, and/or replaced by a push operation in the deployment environment 300.

According to certain embodiments, the AIP 310 is configured to select and/or couple to one or more sensors 320 dynamically. In certain examples, the AIP 310 is configured to select and/or couple to one or more sensors 320 based upon a configuration (e.g., a system configuration, a user configuration) and/or an input (e.g., a user input, an input received via a software interface). In some examples, the AIP 310 is configured to change the one or more selected sensors 320 automatically or dynamically, for example, based on a command received via a software interface.

According to some embodiments, AIP 310 is configured to change the coupling and selection of the one or more sensors 320 and the one or more models 330 dynamically during the deployment environment (e.g., hot swap), without interrupting the operation. As an example, the AIP 310 is configured to couple the sensor 320A to the model 330A and couples the sensor 320B to the model 330B. In such example, during the operation, the AIP 310 changes the coupling of the sensor 320B to the model 330B. In some examples, AIP 310 combines sensor data from two or more sensors 320 and provides the combined sensor data (with or without processing) to one or more models 330. In certain examples, AIP 310 is configured to couple sensor data from a selected sensor 320 to one or more models 330. For example, the sensor 320A is an image sensor to collect videos, AIP 310 is configured to couple the sensor data collected from the sensor 320A to the model 330A when the sensor 320A takes videos in the air (e.g., wildfire videos) and AIP 310 is configured to couple the sensor data collected from the sensor 320A to the model 330B when the sensor 320A takes videos in the water (e.g., sea creature videos).

According to certain embodiments, various combinations of the AIP 310, the sensors 320, and/or the models 330 are disposed in one or more edge devices (not shown). For example, the AIP 310, the sensor 320A and the model 330A are disposed in a first edge device, and the AIP 310, the sensor 320B and the model 330B are disposed in a second edge device. As an example, the AIP 310 and the sensor 320A are disposed in an edge device. For example, the AIP 310 and the model 330A are disposed in an edge device. In some examples, the AIP 310, one or more sensors 320, and/or one or more models 330 are disposed in an edge device 305. For example, the edge device (e.g., the edge device) 305 is a satellite, and the one or more sensors 320 is are orbiting sensors. As an example, an edge device is an aircraft, a submarine, and/or a vehicle. As an example, an edge device includes one or more sensors in the air, in the space, under the sea, in the water, on the land, and/or at other locations.

According to some embodiments, the one or more selected models 330 are configured to generate one or more insights based on the processed sensor data. In some examples, the open API 316 is configured to couple to one or more user devices 340. In certain examples, the AIP 310 is configured to transmit collected sensor data, processed sensor data, and/or one or more insights to one or more user devices 340.

As discussed above and further emphasized here, FIG. 3 is merely an example. One of ordinary skill in the art would recognize many variations, alternatives, and modifications. For example, at least one sensor of the one or more sensors 320 is replaced by a sub-system that includes one or more components that are not sensors. As an example, at least one model of the one or more models 330 is a micro-model.

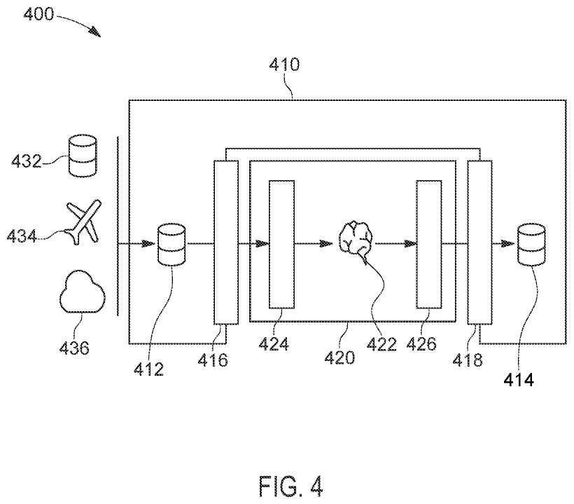

FIG. 4 is an illustrative AIP diagram according to certain embodiments of the present disclosure. FIG. 4 is merely an example. One of ordinary skill in the art would recognize many variations, alternatives, and modifications. According to some embodiments, AIP is a modular approach (e.g., a completely modular approach) to sensor processing. For example, AIP takes in sensor feeds (e.g. arbitrary sensor feeds, video) and then decodes the incoming sensor data (e.g., video stream) into consumable messages, so that one or more models (e.g., one or more 3rd party processing models) can interact with the sensor data (e.g., in a very simple way). As an example, an incoming real-time video stream with binary metadata is decoded into a simple frame (e.g., a picture) and corresponding metadata into a data package defined in an interface definition language (e.g., a platform-neutral data format, a language-neutral data format, protocol buffers (protobuf), protobuf over remote procedure call message) sent to the respective processors (e.g., computational models). As used herein, a processor refers to a computational model. In some embodiments, a processor refers to a computational model in execution.

In certain embodiments, AIP is also built in a way where it is light-weight (e.g., extremely light-weight) so AIP can be scaled up and/or down. For example, this allows a computing system using the AIP to deploy the same software on large servers (e.g., GPU (graphics processing units)) in a data center and/or deploy the same software to a small chip on a satellite. As an example, AIP is deployed in the cloud for video processing (e.g., large-scale video processing).

In some embodiments, AIP is deployed at the edge onto physical devices. For example, AIP is deployed onto one or more aircrafts (e.g., one or more unmanned aircrafts and/or one or more manned aircrafts), one or more vehicles, one or more boats, one or more processing plants. As an example, AIP is deployed to one or more satellites.

According to certain embodiments, the AIP system 400, for example, an AIP development and management platform (DMP) 400, includes an AIP 410, for example, running on an orchestrator service. In some embodiments, the AIP 410 includes an indication of a model pipeline 420 including one or more computational models, for example, running on a model service. In some embodiments, the AIP 410 is configured to process data into processed data (e.g., AI-ready data), to be stored and accessed from a data repository 412. In certain embodiments, the AIP 410 includes a first data repository 412 to receive and store input data (e.g., AI-ready data), a second repository 414 to receive and store model output data, a first API (e.g., data API) to receive sensor data, and a second API (e.g., inference API) to receive model output. In certain embodiments, the AIP 410 is configured to select one or more models based at least in part on one or more data characteristics, one or more processing characteristics and/or one or more user feedback. In certain examples, the processing characteristic may include a video frame extraction, an imaging processing, an object recognition, a decoding, an encoding, and other data processing characteristic. In some examples, the data characteristic may include an input data type (e.g., a sensor data type), an input data format (e.g., sensor data format), an input data volume, an input data range, an output data type, an output data format, and/or the like.

In some embodiments, the DMP 400 is configured to select two or more models to run in parallel in the model pipeline 420, where a first model's input has a first data format and a second model's input has a second data format. In certain examples, the first data format is the same as the second data format. In some examples, the first data format is different from the second data format. In certain embodiments, the DMP 400 is configured to select two or more models to run in sequence in the model pipeline 420, where a first model's output is an input to a second model. In some embodiments, the DMP 400 is configured to select two or more models running in parallel, where the two or more models generate respective model outputs provided to a third model. In certain embodiments, the third model has a software interface to receive results from the two or more models. In some embodiments, the model pipeline 420 includes an input vector 424 to receive data from the data API 416, one or more models 422, and an output vector 426 to output data to the inference API 418.

According to certain embodiments, the AIP system 400 is configured to receive historical data 432, sensor data 434 (e.g., real-time sensor data), and/or data from data repository 436 (e.g., security data repository) to select, develop, update, test, and/or evaluate the AIP 410 and/or the model pipeline 420. In some embodiments, the AIP 410 is configured to process the historical data 432, sensor data 434, and/or data from data repository 436 to generate AI-ready data, for example, data ready to be used with data API 416.

According to some embodiments, providing artificial intelligence (AI) and machine learning (ML) models with a steady stream of data is important (e.g., critical) to one or more models delivering one or more performant results. For example, the one or more models that can speedily consume and process data live “on the fly” allow any AI-derived insights to be used immediately, expediting the delivery of outcomes. In certain examples, in some settings, such as remote, air, space, edge, and/or other disconnected environments, it is important to quickly, consistently, and/or constantly transfer streaming data to the one or more models. For example, the streaming data include high-scale and/or noisy sensor data and/or full motion video (FMV). In some examples, this task is implemented by a system that is: (1) agnostic to one or more model frameworks; (2) modular—to allow for different configurations depending on the desired use case; and/or (3) lightweight and/or deployable where the data is being collected—so that the one or more models are developed and re-trained even when networks are unavailable. For example, the AIP accelerates model improvement and the efficacy of AI so one or more organizations can devote their resources to one or more other efforts, such as researching, developing, training, and/or refining one or more models.

According to some embodiments, one or more solutions are described. For example, AIP is integrated into or operated with a system (e.g., a data integration system). As an example, an AI Inference Platform (AIP) manages and orchestrates the dynamic consumption of data by models. For example, this portable solution helps provide useful AI outputs wherever fielded for live model development and re-training. As an example, the AIP serves as an AI orchestration engine for connecting data to one or more models and/or is responsible for running one or more models in real-time. For example, the AIP is used in conjunction with the AI development and management platform and/or the AI operations platform.

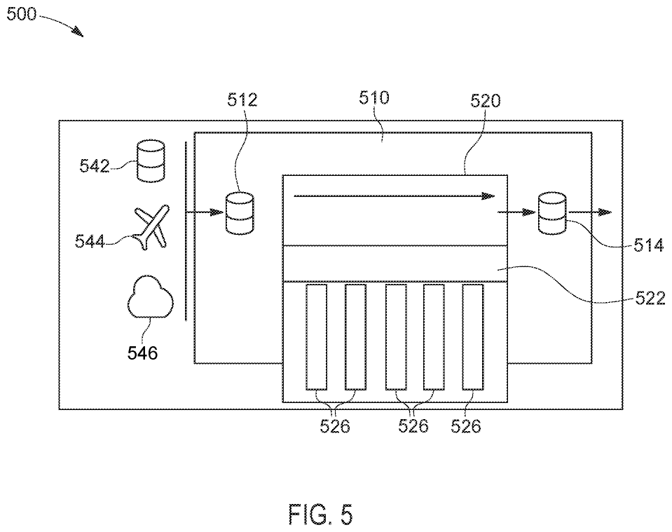

FIG. 5 is an example AIP architecture diagram 500 in accordance with certain embodiments of the present disclosure. FIG. 5 is merely an example. One of ordinary skill in the art would recognize many variations, alternatives, and modifications.

According to some embodiments, AIP is a highly configurable and modular infrastructure for dynamic model orchestration. In some examples, the AIP consumes media streams from a variety of sensors (e.g., live FMV feeds) and applies one or more optional processors (e.g., containerized microservices including the information necessary to run, such as libraries and drivers) to produce consistent video outputs. In certain examples, using both video and sensor inputs, the AIP equips users with a configuration interface for interacting with sensor data and/or managing one or more models and their connection to data through open APIs. Specifically, as an example, the AIP produces individual frames of imagery data and metadata for models to correct and analyze in order to augment live feeds. For example, the AIP is configurable and interoperable, facilitating the rapid deployment and application of AI/ML across one or more data types and one or more use cases.

According to certain embodiments, the AIP architecture 500 includes the AIP 510, for example, running on an orchestration service. In some embodiments, the AIP 510 includes a first repository 512, a second repository 514, an indication of a model pipeline 520 including one or more models, for example, running on a runtime service, and one or more APIs 522. In some embodiments, the AIP 510 is configured to process data into processed data (e.g., AI-ready data), to be stored and accessed from a data repository 512. In certain embodiments, the first data repository 512 is configured to receive and store processed data (e.g., AI-ready data) and the second repository 514 to receive and store model output data. In some embodiments, the one or more APIs 522 include a first API (e.g., data API) to send and/or receive sensor data, and a second API (e.g., inference API) to send and/or receive model output.

In some embodiments, the AIP 510 is configured to interface with two or more models 526 to run in parallel in the model pipeline 520, where a first model's input has a first data format and a second model's input has a second data format. In certain examples, the first data format is the same as the second data format. In some examples, the first data format is different from the second data format. In certain embodiments, the AIP 510 is configured to interface with two or more models 526 to run in sequence in the model pipeline 520, where a first model's output is an input to a second model. In some embodiments, the AIP 510 is configured to interface with two or more models running in parallel, where the two or more models 526 generate respective model outputs provided to a third model. In certain embodiments, the third model has a software interface to receive results from the two or more models. In some embodiments, the model pipeline 520 includes an input vector to receive data from a first API 522, the one or more models 526, and an output vector to output data to a second API 522.

According to certain embodiments, the AIP 510 is configured to receive historical data 532, sensor data 534 (e.g., real-time sensor data), and/or data from data repository 536 (e.g., security data repository) to select, develop, update, test, and/or evaluate the AIP 510 and/or the model pipeline 520. In some embodiments, the AIP 510 is configured to process the historical data 532, sensor data 534, and/or data from data repository 536 to generate AI-ready data, for example, data ready to be used with API 522.

According to certain embodiments, the AIP includes one or more tools to streamline and automate complex data engineering tasks. In some examples, the AIP provides an interface (e.g., an intuitive interface) and one or more tools for users to iterate on one or more models and support their work. In certain examples, it can be applied to a wide variety of use cases, such as video stabilization, object detection, geo-registration, and movement detection and prediction, where one or more corresponding models can be selected and deployed.

According to certain embodiments, the AIP provides live, portable model re-training. While other AI solutions may drop video, in some examples, the AIP produces consistent video outputs. In certain examples, one or more models can be instantly updated and deployed on live feeds with little to no downtime, tightening the feedback loop in model re-training.

According to some embodiments, the AIP includes adaptive runtime configuration. In some examples, AI pipelines are tailored to run operation-specific and one or more complementary models as processors in parallel or with set dependencies on other processors. In certain examples, users can hot swap one or more models in real-time without worrying about breaking model outputs. As an example, the AIP also enables models to use video recordings or live video inputs, if desired.

According to certain embodiments, the AIP includes a lightweight and/or modular interface that can conduct one or more compute processes (e.g., one or more critical compute processes) in remote or resource-constrained environments. As an example, the AIP fits onboard aircraft, unmanned aerial vehicles, boats, or in the cloud where it can push detections to small, handheld devices, saving valuable time. In certain examples, deploying AIP at the point of use also enables AI detections (e.g., optimum quality AI detections) derived from the video inputs (e.g., high-quality video inputs). In some examples, the AIP sends out a “metadata-only” stream, which uses only a fraction of available bandwidth, minimizing strain on the data link. As an example, in an operational testing, the AIP uses less than 10% of available bandwidth. For example, by running one or more models on a minute form factor, the AIP makes smart or autonomous sensor work possible.

According to some embodiments, there is a wide range of use cases for the AIP (e.g., user cases across government, use case across various industries). In certain examples, the AIP processes live FMV feeds. As an example, the AIP is deployed to a ground-based site for large-scale processing of multiple feeds from a Unified Video Dissemination System (UVDS) pipe. For example, a UVDS processes live FMV feeds to improve situational awareness, supporting rapid decision making.

In some examples, the AIP system detects objects in disconnected environments. In some examples, the AIP can deploy at the tactical edge. For example, the AIP runs on one or more cameras on ships to accurately detect and classify boats on the horizon as friendly or adversarial. In certain examples, the AIP improves manufacturing inefficiencies. As an example, the AIP is lightweight and runs on one or more security cameras in manufacturing plants to increase efficiencies for businesses using one or more computer vision algorithms. For example, one way AIP is used is to facilitate automated analysis of information and AI-enabled alerts for businesses, such as understanding patterns of movement for social distancing (e.g., pandemic related social distancing) to reroute pathways and/or flagging crowded areas of concern.

According to certain embodiments, the AIP generates various outcomes. In some examples, the AIP produces reliable AI outputs even when faced with complex streaming data. As an example, using an AIP, customers can orchestrate one or more complex flows of streaming data for model insight and generation live at the edge, even in bandwidth-constrained environments (e.g., severely bandwidth-constrained environments). For example, users have access to one or more consistent model outputs in real-time that can be configured without breaking, which builds trust in one or more models and supports smarter decision-making. As an example, users can move from basic insights to continuously learning and improving AI and ML-driven operations.

In certain examples, the AIP supports automation. As an example, the AIP enables complex, multi-model analysis, and/or automating the selection of a model based on specific circumstances and workflows. In some examples, the AIP speeds outcomes. For example, the AIP supports the delivery of AI/ML technologies in a manner that allows humans and computers to specialize in the skills they do best, expediting AI/ML outcomes.

According to certain embodiments, as the data generated by orbital sensors continues to increase in volume and complexity, the ability to run AI onboard satellites or satellite sensors is important (e.g., critical). In some examples, deploying AI at the edge of space allows for efficient and consistent processing of noisy, high-scale data (e.g., GEOINT (geospatial intelligence) data, RF (radio frequency) data), reducing the amount of data that needs to be stored and transmitted and/or enabling low-latency decision-making for near real-time actions, such as tasking a sensor to perform a job. In certain examples, AIP deployed directly onboard spacecraft accelerates model deployment and improvement, improves data processing, and/or reduces the need to downlink data before taking action.

According to some embodiments, one or more solutions are described. For example, AIP is integrated into or operated with a system (e.g., a data integration system). As an example, an AI Inference Platform (AIP) is an AI orchestration and fusion platform designed to run on cloud infrastructure, on-premise GPU servers, and/or size, weight, and power (SWaP) optimized hardware for embedding into satellites. In some examples, AIP connects data to one or more algorithms, runs those algorithms in real-time, and/or produces one or more outputs that can either be used onboard by other systems or transmitted to ground. As an example, when coupled with a system (e.g., a development and management platform (DMP)), AIP allows one or more DMP-managed AI models to be seamlessly deployed from cloud to space. For example, insights from the one or more edge-deployed models can flow back into the DMP, advancing the retraining and Continuous Integration/Continuous Deployment (Cl/CD) of one or more models across satellite constellations.

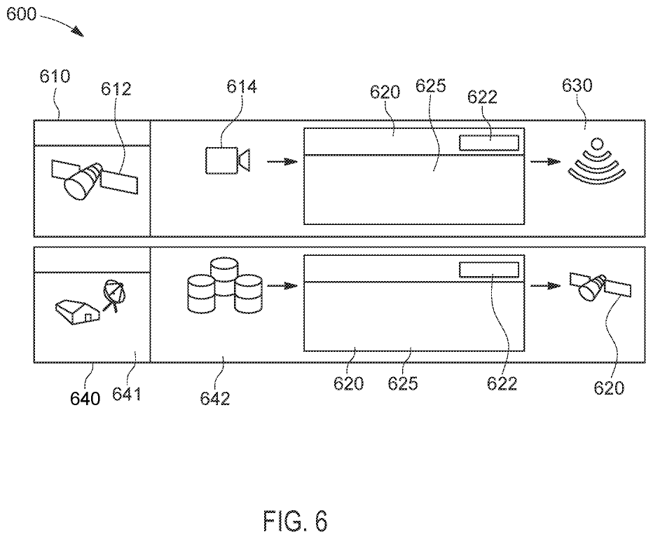

FIG. 6 is an illustrative an AIP architecture 600 (e.g., an AIP and DMP architecture) diagram according to certain embodiments of the present disclosure. FIG. 6 is merely an example. One of ordinary skill in the art would recognize many variations, alternatives, and modifications.

According to some embodiments, the AIP architecture 600 includes an AIP system 610 and a DMP system 640. In certain embodiments, the AIP system 610 includes an edge device 612, sensor data 614 (e.g., real-time sensor data), an AIP 620 on a runtime service running one or more models 625 via one or more interfaces 622, and model outputs 630. In some embodiments, the AIP architecture 600 includes a device 641 (e.g., a device at a ground station), one or more data repository 642, an AIP 620 running on a development service for developing, testing, and deploying one or more models 625 via the one or more interfaces 622, and generate the AIP 620 with one or more models 625.

In certain embodiments, AIP 620 is a highly configurable and modular infrastructure for dynamic model orchestration. For example, AIP consumes media streams from a variety of sensors (e.g., SAR (synthetic aperture radar) data, EO/IR (electro-optical/infrared) imagery, RF data, and/or FMV feeds) and applies one or more optional AI processing (e.g., containerized micro models including all necessary dependencies to run, such as libraries and drivers) to produce AI outputs. As an example, using diverse sensor inputs, AIP provides users at ground stations with a configuration interface for interacting with sensor data and managing one or more models and their connection to data through one or more open APIs. In some examples, AIP handles a variety of input formats, such as real-time streaming RTP/RTSP (Real-time Transport Protocol/Real Time Streaming Protocol), NITF (National Imagery Transmission Format Standard), GeoTIFF (Geostationary Earth Orbit Tagged Image File Format), and/or, as FMV comes to space, MPEG-TS (MPEG transport stream) over UDP or from a file. In certain examples, as a configurable and interoperable system, AIP supports outputs in a variety of standard formats (e.g., open standard formats), such as XML, CoT, and GeoJSON, which enable sending data and insights downstream to other subsystems with little to no integration work required.

According to certain embodiments, AIP includes one or more tools to streamline and automate complex data engineering tasks. In some examples, AIP includes one or more Computer Vision (CV) Models. For example, AIP provides an intuitive interface and one or more tools for users to iterate on one or more CV models in support of objectives, such as space situational awareness, vessel/vehicle tracking, facility activity analysis, land use or construction, and/or others. In certain examples, AIP includes one or more RF Processing. For example, AIP supports one or more algorithms for automating the analysis of signals by signature. As an example, AIP supports pre-processing of the data, such as filtering incoming signals to reduce noise and/or splitting up waves into parts, for example, via Fourier transforms.

In some examples, AIP includes one or more image processing. For example, rendering EO or SAR collects into images (e.g., useful and/or useful, high-quality images) for analysis by humans or algorithms can require, all of which can be applied in AIP. As an example, performing the one or more image corrections at the sensor is an enabler for one or more fusion workflows onboard the spacecraft. Additionally, for example, as many AI models are trained on corrected data in machine learning environments, they require various corrected imagery at the point of collection. As an example, AIP includes an interface to one or more orthorectification models, which are for correcting optical distortions from sensor angles. For example, AIP includes an interface to one or more pan-sharpening models for creating a color image (e.g., high-resolution color image) out of one or more panchromatic and multi spectral images. As an example, AIP includes an interface to one or more georegistration models for correcting geospatial information on the image to generate more precise coordinates. For example, AIP includes an interface to one or more image formation models for turning SAR data into images. As an example, AIP includes an interface to one or more tiling models for breaking a large image into one or more tiles (e.g., consumable chunks of pixels), for example, that a CV model can handle, and then handling the merging of detections and AI insights across one or more tiles back into a single view.

According to some embodiments, AIP includes adaptive runtime configuration. For example, AI pipelines are tailored to run one or more operation-specific and small, modular models (“micro models”) as processors in parallel or with set dependencies on one or more other processors. As an example, AIP allows for switching out one or more algorithms as needed and optimizing on factors including quality of output, speed, and/or bandwidth. In some examples, importantly (e.g., critically), one or more micro models can be hot swapped in real-time without breaking model outputs and/or requiring massive software baseline changes.

According to certain embodiments, AIP includes a lightweight and/or modular interface that can conduct one or more compute processes (e.g., critical compute processes) in one or more remote or resource-constrained environments. For example, AIP runs on an organization's specialized satellite compute hardware and/or other, low-SWaP form-factors. As an example, this allows organizations to AI-compress data into “insight-first” streams to the earth, optimizing scarce bandwidth to ground stations (e.g., a computing device at a ground station). In certain examples, by running models on a minute form factor, AIP makes smart and/or autonomous sensor work possible. In some examples, deploying AIP at the point of use enables one or more AI detections (e.g., optimum quality AI detections) derived from the one or more sensor inputs (e.g., high-quality highest sensor inputs, highest quality sensor inputs).

According to some embodiments, AIP is applied to one or more use cases. In some examples, AIP is used for efficiently analysis in space. For example, with AIP deployed onboard spacecraft, one or more sophisticated AI models are rapidly integrated and swapped out as objectives evolve, feedback is received, and/or one or models are retrained. As an example, with low-latency decision-making possible at the edge, AIP reduces or removes the need to downlink before the next action.

In certain embodiments, AIP is used for tasking. As an example, satellite companies integrate their tasking and/or catalog API into a system (e.g., a data integration system), allowing users to task a constellation. For example, with AIP capturing one or more key parameters of customer requests, such as geographic area, time period, and/or the desired objects, a new data asset (e.g., a powerful new data asset) is generated that can be combined with the corresponding sensor data for advanced modeling and one or more new opportunities.

In some embodiments, AIP is used for sensor correlation. For example, AIP supports one or more multi-sensor models to fuse data across one or more diverse payloads. As an example, if a customer uses RF and EO collection, they can field one or more AI models with DMP, combining both modalities to achieve higher fidelity in detecting one or more entities of interest (e.g., military equipment). For example, the one or more fusion models are deployed to AIP and run onboard spacecraft.

In certain embodiments, AIP is used for command and control. As an example, AIP enables customers to achieve a sensor-to-actor workflow (e.g., a sensor-to-shooter workflow). For example, after sending a tasking from a ground station to a satellite with AIP, the software orchestrates the imaging, localization, and/or AI detection of a target, ultimately sending that target directly to terrestrial shooters, such as strike aircraft over secure protocols (e.g., JREAP-C, a U.S. military standard for transmitting tactical data messages over one or more long-distance networks, such as one or more satellite links).

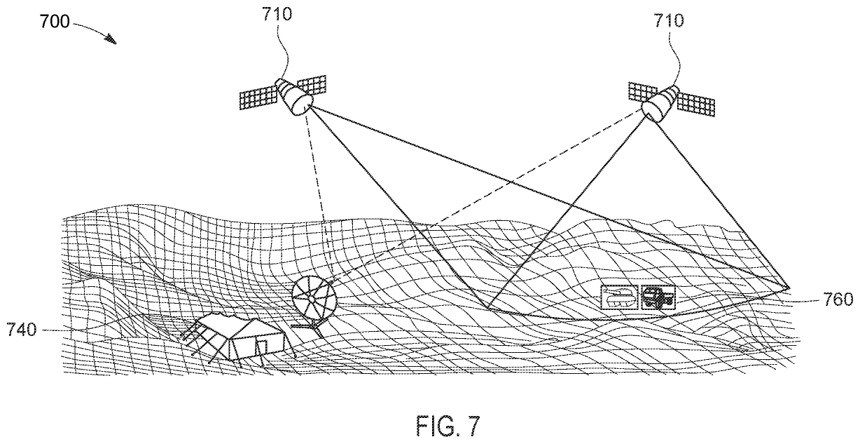

FIG. 7 is an illustrative AIP system 700 according to certain embodiments of the present disclosure. FIG. 7 is merely an example. One of ordinary skill in the art would recognize many variations, alternatives, and modifications. In some embodiments, the AIP system 700 includes one or more edge devices 710 and a DMP 740. In certain embodiments, the edge devices 710 run one or more AIPs onboard. In some examples, the edge devices 710 with the AIPs to conduct real-time AI/ML for multi-sensor correlation and detection of objects 760. In certain embodiments, the DMP 740 is configured to develop, evaluate and deploy AIPs with interfaced one or more models to the edge device 710. In some embodiments, the edge devices 710 can be deployed to one or more satellites.

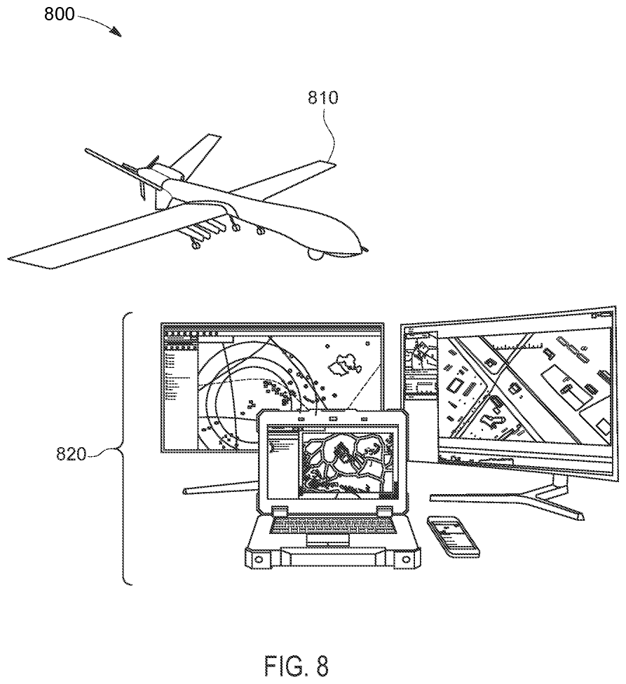

FIG. 8 is an illustrative AIP system 800 according to certain embodiments of the present disclosure. FIG. 8 is merely an example. One of ordinary skill in the art would recognize many variations, alternatives, and modifications. In some embodiments, the AIP system 800 includes one or more edge devices 810 and a DMP 820. In certain embodiments, the edge devices 810 run one or more AIPs onboard, for example, with the one or more models. In certain embodiments, the DMP 820 is configured to develop, evaluate, deploy, and update AIPs with interfaced one or more models to the edge device 810. In some embodiments, the edge devices 810 can be deployed to one or more satellites.

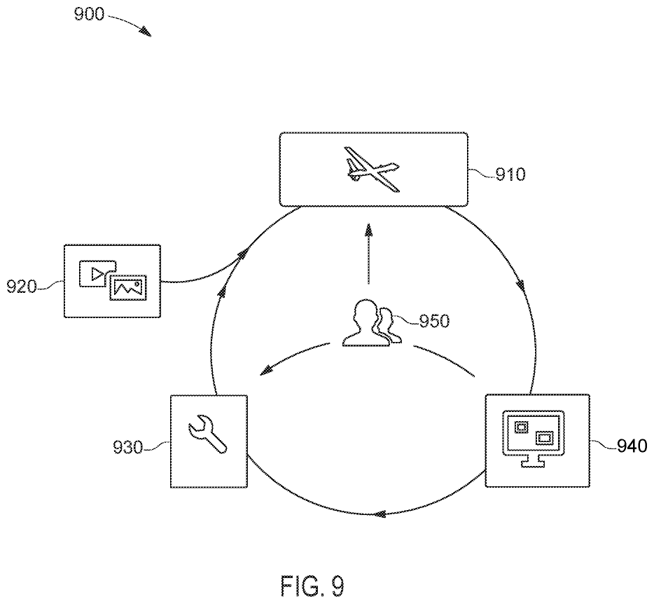

FIG. 9 is an illustrative AIP system 900 according to certain embodiments of the present disclosure. FIG. 9 is merely an example. One of ordinary skill in the art would recognize many variations, alternatives, and modifications. In some embodiments, the AIP system 900 includes or interfaces with one or more AIPs 910 running on edge devices, one or more data feed 920 (e.g., video, imagery, etc.), a data management platform 930, one or more decision-making applications 940, and one or more feedback mechanism 950. In some embodiments, the edge devices, by running the AIPs 910, can perform real-time AI/ML on the edge. In certain embodiments, the one or more feedback mechanism 950 is via software interface, user interface, and/or other input mechanism and communication mechanism. As used herein, in some embodiments, feedback includes one or more of commands, controls, results, and messages. In some embodiments, the AIP system 900 can update, retrain, select, and/or delete one or more models based on the feedback. In certain embodiments, the decision-making applications 940 can provide feedback to the AIPs 910. In some embodiments, the decision-making applications 940 can provide feedback to the data management platform 930.

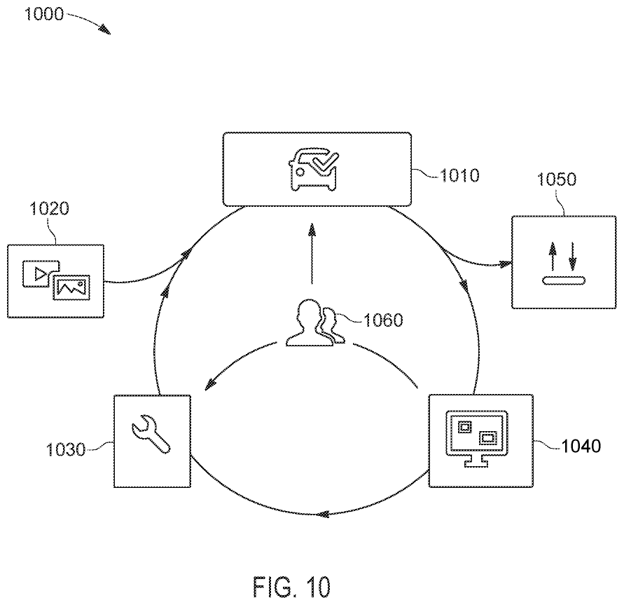

FIG. 10 is an illustrative AIP system 1000 according to certain embodiments of the present disclosure. FIG. 10 is merely an example. One of ordinary skill in the art would recognize many variations, alternatives, and modifications. In some embodiments, the AIP system 1000 includes or interfacing with one or more AIPs 1010 running on edge devices, one or more data feed 1020 (e.g., video, imagery, etc.), an AI platform 1030 for training, evaluating, deploying, and managing AI/ML, one or more analytics software 1040 for capturing, analyzing, and understanding trends on historical data 1040, one or more external systems 1050 to communicate with other devices locally, and one or more feedback mechanism 1060. In some embodiments, the edge devices, by running the AIPs 1010, can perform real-time AI/ML on the edge. In certain embodiments, the one or more feedback mechanism 1060 is via software interface, user interface, and/or other input mechanism and communication mechanism. As used herein, in some embodiments, feedback includes one or more of commands, controls, results, and messages. In some embodiments, the AIP system 1000 can update, retrain, select, and/or delete one or more models based on the feedback. In certain embodiments, the analytics software 1040 can provide feedback to the AIPs 1010. In some embodiments, the analytics software 1040 can provide feedback to the AI platform 1030.

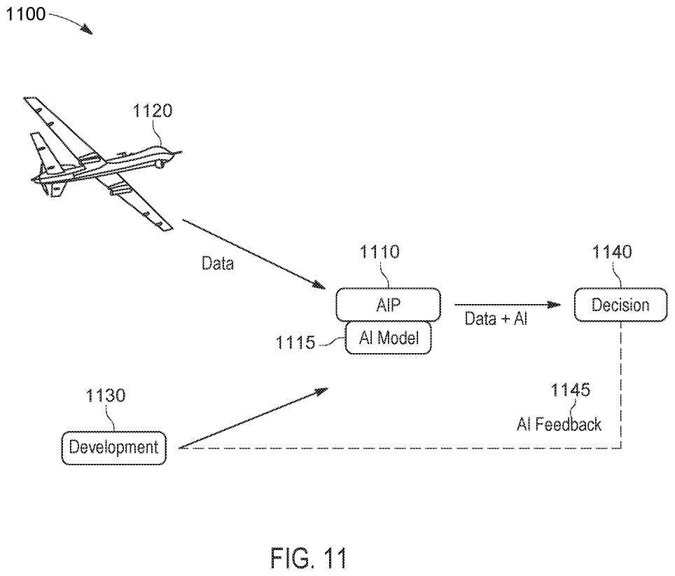

FIG. 11 is an illustrative flow diagram for an AIP system 1100 according to certain embodiments of the present disclosure. FIG. 11 is merely an example. One of ordinary skill in the art would recognize many variations, alternatives, and modifications. In some embodiments, the AIP system includes one or more AIPs 1110, one or more AI models 1115 interfaced with the AIPs 1110, and one or more edge device 1120 running at least one of the one or more AIPs 1110, a decision system 1140, and a development system 1130. In certain embodiments, the one or more AIPs 1110 receive data (e.g., video data) from the one or more edge devices 1120 and orchestrate the one or more AI models 1115 to the received data (e.g., live sensor feed, real-time video data). In some embodiments, the one or more AI models 1115 are applied to the data received from the one or more edge devices 1120 and generate data and AI results to be sent via the one or more AIPs 1110. In certain embodiments, the decision system 1140 processes the data and AI results to generate one or more decisions and AI feedback 1145. In some embodiments, the AIP feedback 1145 is used by the development system 1130 (e.g., a DMP) of the one or more AIPs 1110 and the one or more AI models 1115. In certain embodiments, the development system 1130 holds the training data and models. In some embodiments, new models, including updated models, are pushed or published from the development system 1130 to the AIP 1110 (e.g., AIPs globally).

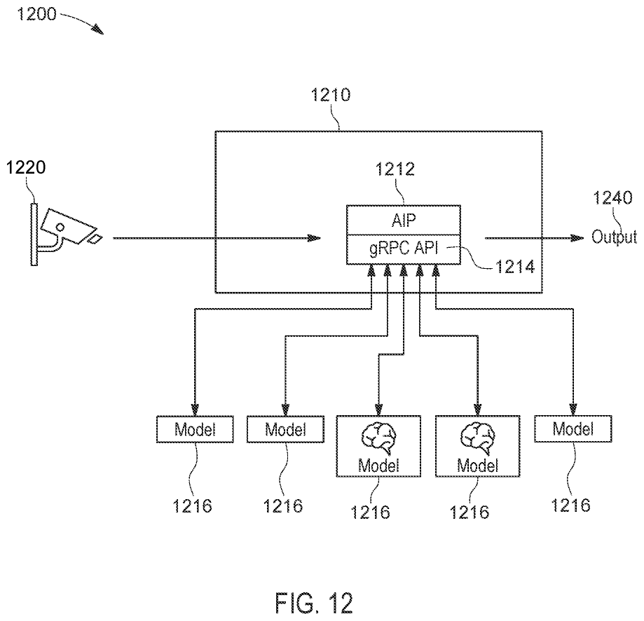

FIG. 12 is an illustrative example of an AIP system 1200 according to certain embodiments of the present disclosure. FIG. 12 is merely an example. One of ordinary skill in the art would recognize many variations, alternatives, and modifications. In some embodiments, the AIP system 1200 includes an AIP 1212, an edge device 1220, and one or more models 1216. In certain embodiments, the edge device 1220 can generate one or more of FMV, CCTV (closed-circuit television), satellite imagery, ELINT (electronic signals intelligence)/SIGINT (signal intelligence) (e.g., scoping), audio (e.g., scoping), and/or acoustics (e.g., scoping). In some embodiments, the AIP 1212, by applying the one or more models (e.g., a stabilization and calibration model, a georegistration model, one or more AI models, a tracker model) to the received data, generates one or more outputs, such as a video (e.g., MPEG-TS video), video combined with georegistered telemetry data and AI outputs, cursor-on-target (CoT) data, HLS-AVRO data, JSON data (e.g., an open standard data-interchange format), and/or the like.

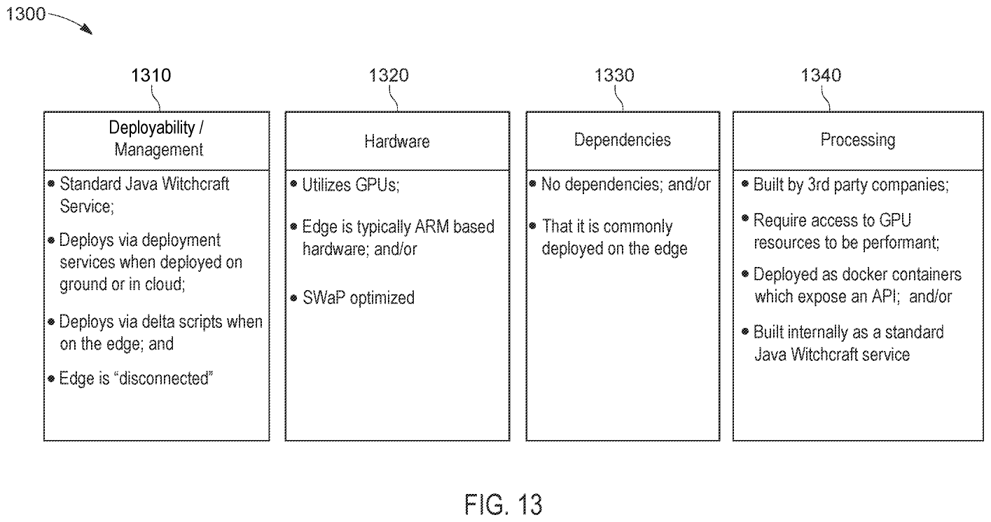

FIG. 13 is an illustrative example of features 1300 of an AIP system according to certain embodiments of the present disclosure. FIG. 13 is merely an example. One of ordinary skill in the art would recognize many variations, alternatives, and modifications. In some embodiments, the AIP system has deployability management features 1310, including one or more of: using standard Java Witchcraft service; deploying via deployment services when deployed on ground or in cloud; deploying via delta scripts when on the edge; and/or when edge devices are disconnected. In certain embodiments, the AIP system has hardware features 1320, including one or more of: utilizing GPUs; edge is typically ARM based hardware; and/or SWaP optimizations. In some embodiments, the AIP system has dependency features 1330, including one or more of: no dependencies to a data management system or a decision system; and/or that it is commonly deployed on the edge. In certain embodiments, the AIP system has processing features 1340, including one or more of: built by 3^{rd} party companies (e.g., AI companies); requiring access to GPU resources to be performant; deployed as docker containers which expose an AIP; and/or built internally as a standard Java Witchcraft service.

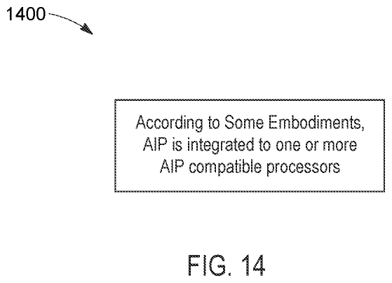

FIG. 14 is an illustrative diagram of an AIP system 1400 according to certain embodiments of the present disclosure. FIG. 14 is merely an example. One of ordinary skill in the art would recognize many variations, alternatives, and modifications. In some embodiments, the AIP system 1400 includes an AIP is integrated to one or more AIP compatible processors.

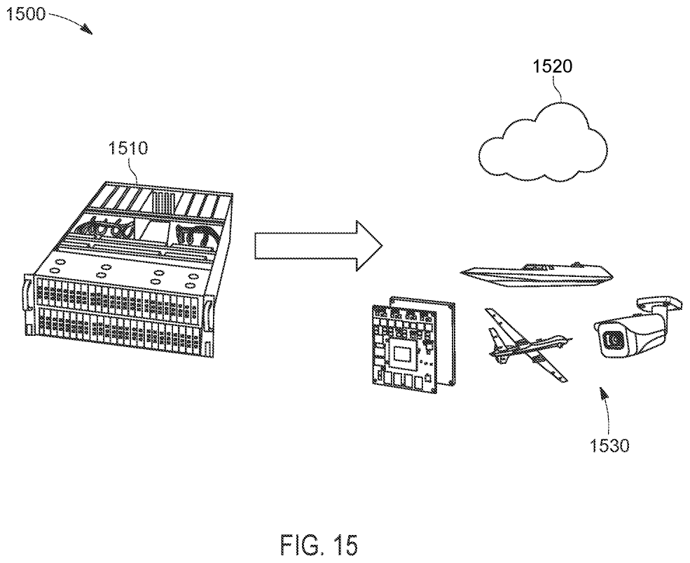

FIG. 15 is an illustrative comparison 1500 of a conventional system 1510 and an AIP system 1520 according to certain embodiments of the present disclosure. FIG. 15 is merely an example. One of ordinary skill in the art would recognize many variations, alternatives, and modifications. In some embodiments, the AIP system 1520 includes components running on the cloud servers 1540 and running on the edge devices 1530. In certain embodiments, the functionality of the conventional system 1510 (e.g., on-premise racks of servers) is pushed into cloud and edge. In some embodiments, the components running on the cloud servers 1540 is dynamically spinning up/down instances of AIP to efficiently provision resources. In certain embodiments, edge devices 1530 include limited computing and/or communication resources (e.g., commonly communications denied environment).

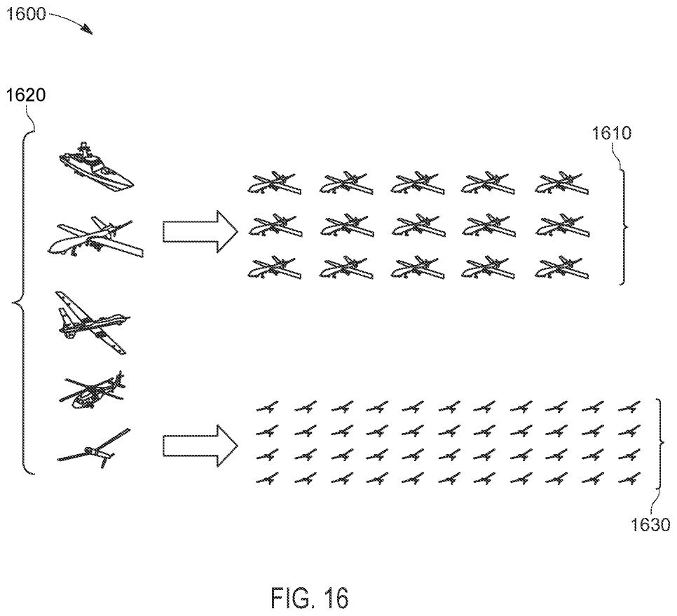

FIG. 16 is an illustrative example deployment environment 1600 from limited edge devices 1620 to a large number of edge devices 1610 and 1630 according to certain embodiments of the present disclosure. FIG. 16 is merely an example. One of ordinary skill in the art would recognize many variations, alternatives, and modifications. In some embodiments, the deployment environment 1600 can include hundreds or thousands of edge devices 1610, 1630, for example, covering a large footprint (e.g., a large geographic area, a large space area).

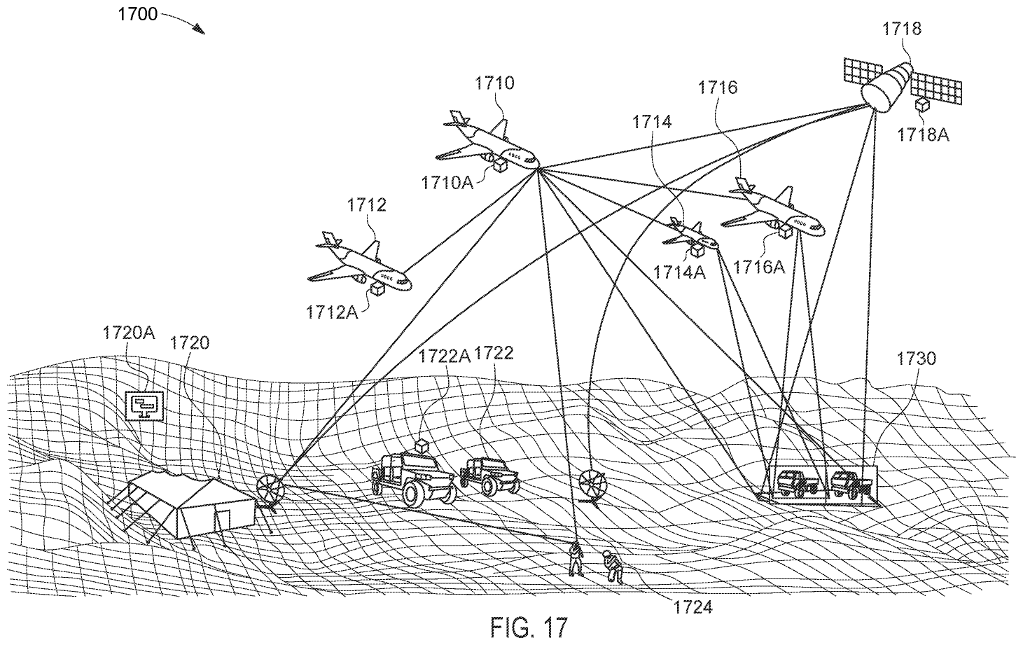

FIG. 17 is an illustrative example of an AIP deployment environment 1700 according to certain embodiments of the present disclosure. FIG. 17 is merely an example. One of ordinary skill in the art would recognize many variations, alternatives, and modifications. In some embodiments, the AIP deployment environment 1700 includes a plurality of edge devices including an aircraft and associated computing device 1710, an aircraft and associated computing device 1712, an aircraft and associated computing device 1714, an aircraft and associated computing device 1716, a satellite and associated computing device 1718, and a vehicle and associated computing device 1722. In certain embodiments, the edge devices each have an associated AIP, for example, AIP 1712A, AIP 1714A, AIP 1716A, AIP 1718A, and AIP 1722A. In some embodiments, one or more of the edge devices include one or more models deployed thereon and to be activated, updated, added, deleted, deactivated by an AIP.

In some embodiments, the AIP deployment environment 1700 includes a ground station 1720 and associated development platform and/or AIP 1720A. In certain embodiments, one or more edge devices (e.g., edge device 1710, edge device 1714, edge device 1716, edge device 1718) detect a target object 1730 in the AIP deployment environment 1700. In some embodiments, a user 1724 can receive AIP results, send commands, configure AIP and models, send data, and perform other activities in the AIP deployment environment.

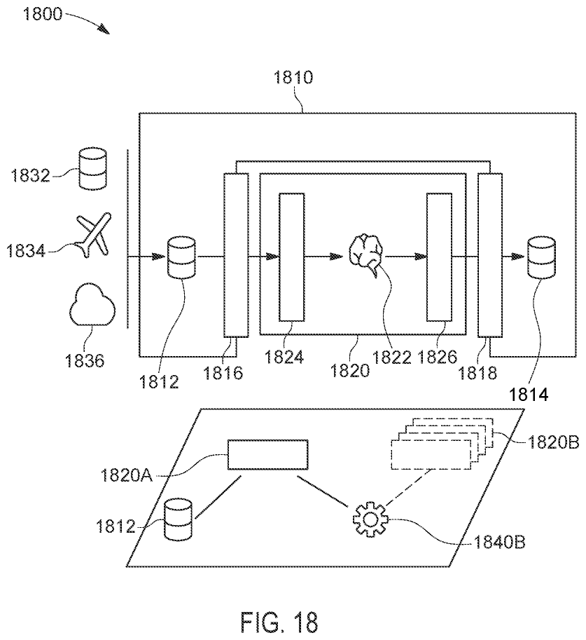

FIG. 18 is an illustrative AIP diagram according to certain embodiments of the present disclosure. FIG. 18 is merely an example. One of ordinary skill in the art would recognize many variations, alternatives, and modifications. According to some embodiments, AIP is a modular approach (e.g., a completely modular approach) to sensor processing. For example, AIP takes in sensor feeds (e.g. arbitrary sensor feeds, video) and then decodes the incoming sensor data (e.g., video stream) into consumable messages, so that one or more models (e.g., one or more 3rd party processing models) can interact with the sensor data (e.g., in a very simple way). As an example, an incoming real-time video stream with binary metadata is decoded into a simple frame (e.g., a picture) and corresponding metadata into a data package.

According to certain embodiments, the AIP system 1800, includes an AIP 1810, for example, running on an orchestrator service, active model service 1820A, inactive model service 1820B, runtime configuration 1840B, and data repository 1812. In some embodiments, the AIP 1810 includes an indication of a model pipeline 1820 including one or more computational models, for example, running on a model service. In some embodiments, the AIP 1810 is configured to process data into processed data (e.g., AI-ready data), to be stored and accessed from a data repository 1812. In certain embodiments, the AIP 1810 includes a first data repository 1812 to receive and store input data (e.g., AI-ready data), a second repository 1814 to receive and store model output data, a first API (e.g., data API) to receive sensor data, and a second API (e.g., inference API) to receive model output. In certain embodiments, the AIP 1810 is configured to select one or more models based at least in part on one or more data characteristics, one or more processing characteristics and/or one or more user feedback. In certain examples, the processing characteristic may include a video frame extraction, an imaging processing, an object recognition, a decoding, an encoding, and other data processing characteristic. In some examples, the data characteristic may include an input data type (e.g., a sensor data type), an input data format (e.g., sensor data format), an input data volume, an input data range, an output data type, an output data format, and/or the like.

In some embodiments, the AIP system 1800 is configured to select two or more models to run in parallel in the model pipeline 1820, where a first model's input has a first data format and a second model's input has a second data format. In certain examples, the first data format is the same as the second data format. In some examples, the first data format is different from the second data format. In certain embodiments, the DMP system 1800 is configured to select two or more models to run in sequence in the model pipeline 1820, where a first model's output is an input to a second model. In some embodiments, the DMP system 1800 is configured to select two or more models running in parallel, where the two or more models generate respective model outputs provided to a third model. In certain embodiments, the third model has a software interface to receive results from the two or more models. In some embodiments, the model pipeline 1820 includes an input vector 1824 to receive data from the data API 1816, one or more models 1822, and an output vector 1826 to output data to the inference API 1818.

According to certain embodiments, the AIP system 1800 is configured to receive historical data 1832, sensor data 1834 (e.g., real-time sensor data), and/or data from data repository 1836 (e.g., security data repository) to select, develop, update, test, and/or evaluate the AIP 1810 and/or the model pipeline 1820. In some embodiments, the AIP 1810 is configured to process the historical data 1832, sensor data 1834, and/or data from data repository 1836 to generate AI-ready data, for example, data ready to be used with data API 1816.

According to some embodiments, AIP is a highly configurable and modular infrastructure for dynamic model orchestration. In some examples, the AIP consumes media streams from a variety of sensors (e.g., live FMV feeds) and applies one or more optional processors (e.g., containerized microservices including the information necessary to run, such as libraries and drivers) to produce consistent video outputs. In certain examples, using both video and sensor inputs, the AIP equips users with a configuration interface for interacting with sensor data and/or managing one or more models and their connection to data through open APIs. Specifically, as an example, the AIP produces individual frames of imagery data and metadata for models to correct and analyze in order to augment live feeds. For example, the AIP is configurable and interoperable, facilitating the rapid deployment and application of AI/ML across one or more data types and one or more use cases.

According to certain embodiments, the AIP system 1800 deploys one or more AIPs and AI models 1820A, 1820B to a runtime service and/or an orchestrator service. In some examples, for sensor agnostic model development, the orchestrator integrates data from any sensor or repository into AI-ready data, enabling one or more models to run on the full range of multi-modal and/or all-source data. In certain examples, for model access to all data, the orchestrator provides models access to one or more data types through an open and/or polyglot interface. For example, one or more models subscribe to relevant data and/or receive it in common, model-ready formats. As an example, no data engineering is needed. In some examples, for standalone AI Models, one or more models are trained and/or run independently of the orchestrator, accelerating iteration. For example, one or more models are added and transfer-learned using one or more standalone adaptors. In certain examples, for runtime model configuration, one or more running models are selected dynamically using one or more configuration files. For example, no code changes are needed to switch models, and/or new models and/or weights are loaded without downtime. In some examples, for symmetrical training & inference, the orchestrator supports training of one or more models, with training data delivered via the data API. For example, this unlocks faster and/or more reliable development cycles, and/or portable re-training that runs at the edge.

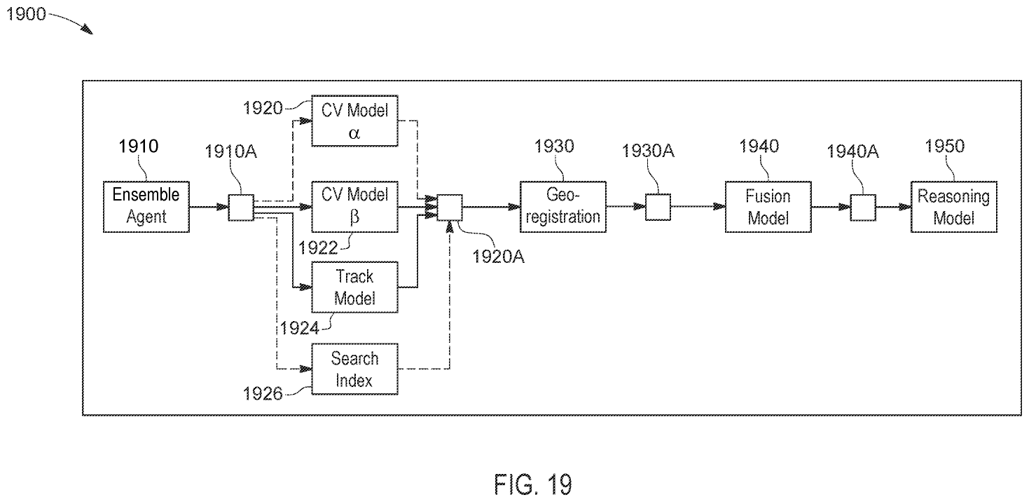

FIG. 19 is an example AIP system 1900 for a use case (e.g., AI microservices mesh related to AI Inference Platform) according to certain embodiments of the present disclosure. FIG. 19 is merely an example. One of ordinary skill in the art would recognize many variations, alternatives, and modifications. In some embodiments, the AIP system 1900 includes one or more models and one or more AIPs, including an ensemble agent 1910, an AIP 1910A, a plurality of models running in parallel (e.g., CV model α 1920, CV model β 1922, track model 1924, search index 1926, etc.), an AIP 1920A, and a plurality of models running in sequence (e.g., a georegistration model 1930, a fusion model 1940, a reasoning model 1950, etc.), and AIPs 1930A, 1940A. In certain embodiments, using a model pipeline (e.g., AI pipelines and parallelism), the AIP service manages multiple models 1910, 1920, 1922, 1924, 1926, 1930, 1940, 1950 running against respective data (e.g., AI-ready data), either in parallel or sequence. In some embodiments, at least two of the AIPs 1910A, 1920A, 1930A, 1940A can be a same AIP. In certain embodiments, the AIPs 1910A, 1920A, 1930A, 1940A can include two or different AIPs. As an example, the ensemble agent 1910 manages which one or more models should run in parallel, while one or more georegistration and fusion models enrich model outputs as part of one or more downstream models (e.g., higher-order pipelines).

In certain embodiments, a fusion model can combine different data and results. In some examples, for real-time and/or asynchronous models, one or more model services subscribe to real-time data feeds and run within configurable time constraints. As an example, one or more models (e.g., search) run asynchronously based on one or more user or algorithmic triggers. In certain examples, for scalable AI microservices, one or more orchestration and model microservices (e.g., each a targeted service) are dynamically scaled up and down as mission requirements and datasets evolve. For example, deploying one or more new models does not affect one or more existing services. In some examples, for cloud-ready and/or edge-ready AI containers, one or more model microservices can be bundled flexibly to optimally use cloud and edge computing resources, managed by the orchestrator.

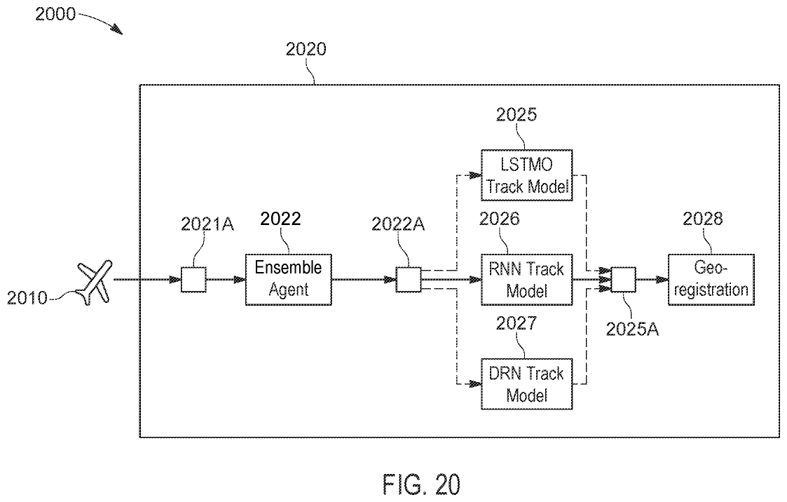

FIG. 20 is an example AIP system 2000 for a use case (e.g., object tracking, real-time object tracking) according to certain embodiments of the present disclosure. FIG. 20 is merely an example. One of ordinary skill in the art would recognize many variations, alternatives, and modifications. In some embodiments, the AIP system 2000 includes an edge device 2010 and an AIP service 2020. In certain embodiments, the AIP service 2020 includes an AIP 2021A, an ensemble agent 2022, an AIP 2022A, a plurality of models running in parallel (e.g., LSTM (long short-term memory) track model 2025, RNN (recurrent neural network) track model 2026, DRN (deep residual networks) track model 2027, etc.), an AIP 2025A, and a georegistration model 2028. In certain embodiments, using a model pipeline (e.g., AI pipelines and parallelism), the AIP service 2020 manages multiple models 2022, 2025, 2026, 2027, 2028 running against its data (e.g., AI-ready data), either in parallel or sequence. In some embodiments, at least two of the AIPs 2021A, 2022A, 2025A can be a same AIP. In certain embodiments, the AIPs 2021A, 2022A, 2025A can include two or different AIPs.

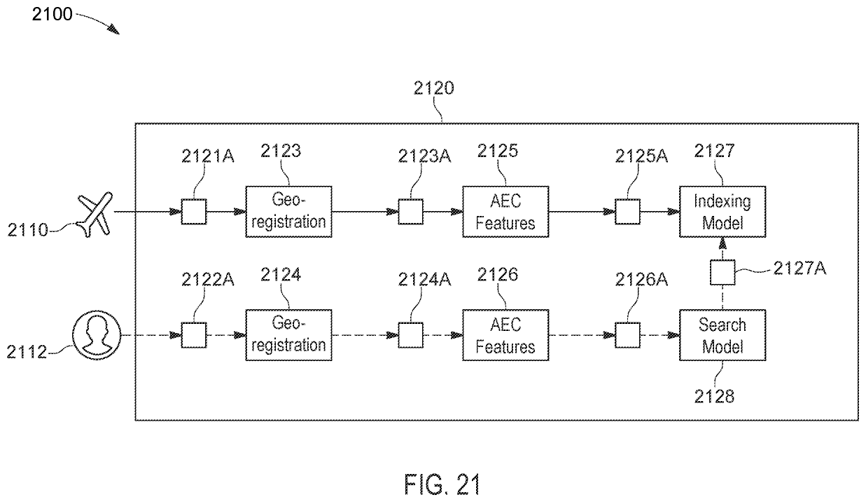

FIG. 21 is an example AIP system 2100 for a use case (e.g., entity recognition, asynchronous entity recognition) according to certain embodiments of the present disclosure. FIG. 21 is merely an example. One of ordinary skill in the art would recognize many variations, alternatives, and modifications. In some embodiments, the AIP system 2100 includes edge devices 2110, 2112, and an AIP service 2120. In certain embodiments, the AIP service 2120 includes AIPs 2121A and optionally AIP 2121A, a georegistration model 2123 with corresponding AIP 2123A, an optional georegistration model 2124 with corresponding AIP 2124A, an AIP 2122A, corresponding AEC (automatic exposure control) features 2125, 2126 and corresponding AIPs 2125A, 2126A, an indexing model 2127A with an AIP 2127A, and a search model 2128. In certain embodiments, using a model pipeline (e.g., AI pipelines and parallelism), the AIP service 2120 manages multiple models 2123, 2124, 2125, 2126, 2127, 2128 running against its data (e.g., AI-ready data), either in parallel or sequence. In some embodiments, at least two of the AIPs 2121A, 2122A, 2123A, 2124A, 2125A, 2126A, 2127A can be a same AIP. In certain embodiments, the AIPs 2121A, 2122A, 2123A, 2124A, 2125A, 2126A, 2127A can include two or different AIPs.

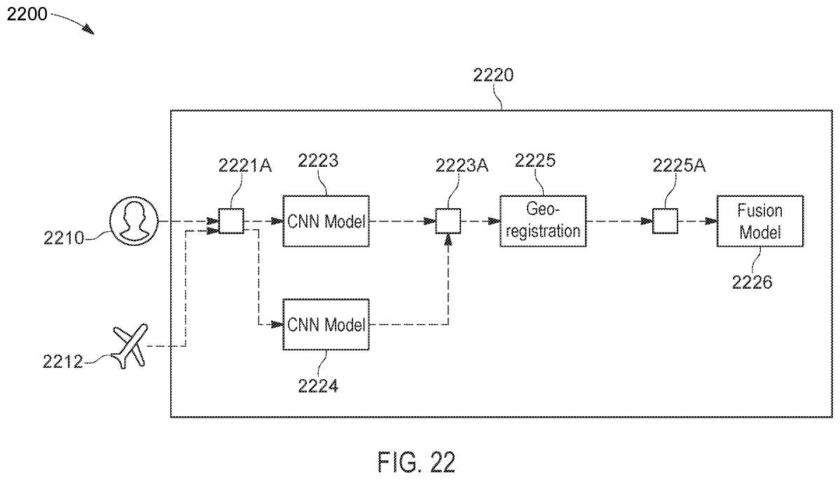

FIG. 22 is an example AIP system 2200 for a use case (e.g., environmental understanding, asynchronous environmental understanding) according to certain embodiments of the present disclosure. FIG. 22 is merely an example. One of ordinary skill in the art would recognize many variations, alternatives, and modifications. In some embodiments, the AIP system 2200 includes edge devices 2210, 2212, and an AIP service 2220 (e.g., an orchestration service). In certain embodiments, the AIP service 2220 includes an AIP 2221A interfacing both of the edge devices 2210 and 2212, a CNN (convolutional neural network) model 2223, a CNN model 2224, an AIP 2223A, a georegistration model 2225 with corresponding AIP 2225A, and a fusion model 2226. In certain embodiments, using a model pipeline (e.g., AI pipelines and parallelism), the AIP service 2220 manages multiple models 2223, 2224, 2225, 2226 running against its data (e.g., AI-ready data), either in parallel or sequence. In some embodiments, at least two of the AIPs 2221A, 2223A, 2225A, 2226A, 2227A can be a same AIP. In certain embodiments, the AIPs 2221A, 2223A, 2225A, 2226A, 2227A can include two or different AIPs.

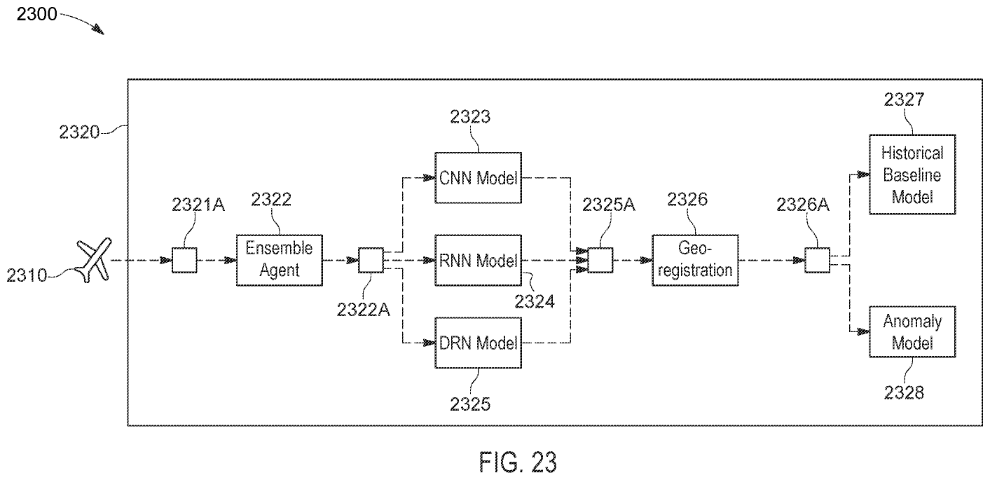

FIG. 23 is an example AIP system 2300 for a use case (e.g., pattern/anomaly detection, real-time pattern/anomaly detection) according to certain embodiments of the present disclosure. FIG. 23 is merely an example. One of ordinary skill in the art would recognize many variations, alternatives, and modifications. In some embodiments, the AIP system 2300 includes an edge device 2310 and an AIP service 2320. In certain embodiments, the AIP service 2320 includes an AIP 2321A interfacing with the edge device 2310, an ensemble agent 2322, an AIP 2322A interfacing with the ensemble agent and a plurality of models, the plurality of models (e.g., a CNN model 2323 (e.g., a CNN model processing EO data), an RNN model 2324 (e.g., an RNN model processing IR data), a DRN model 2325 (e.g., a DRN model processing AOR data), etc.), an AIP 2325A receiving AI model results, a georegistration model 2326 with corresponding AIP 2326A also interfacing downstream models, a historical baseline model 2327 (e.g., a model for determining one or more patterns) and an anomaly model 2326 (e.g., a model for identifying one or more anomalies). In certain embodiments, using a model pipeline (e.g., AI pipelines and parallelism), the AIP service 2320 manages multiple models 2322, 2323, 2324, 2325, 2326, 2327, 2328 running against its data (e.g., AI-ready data), either in parallel or sequence. In some embodiments, at least two of the AIPs 2321A, 2322A, 2325A, 2326A can be a same AIP. In certain embodiments, the AIPs 2321A, 2322A, 2325A, 2326A can include two or different AIPs.

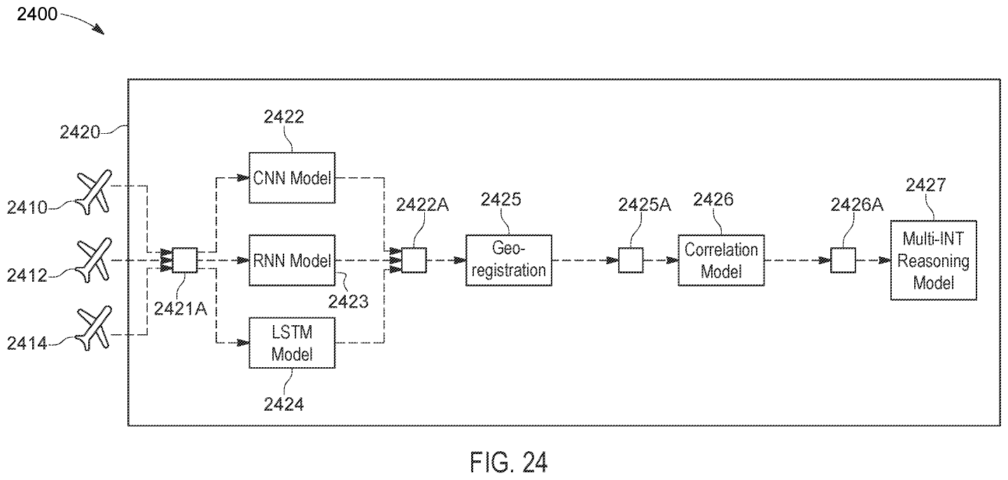

FIG. 24 is an example AIP system 2400 for a use case (e.g., dynamic order, real-time dynamic order) according to certain embodiments of the present disclosure. FIG. 24 is merely an example. One of ordinary skill in the art would recognize many variations, alternatives, and modifications. In some embodiments, the AIP system 2400 includes one or more edge devices 2410, 2412, 2414, and an AIP service 2420. In certain embodiments, the AIP service 2420 includes an AIP 2421A interfacing with the edge devices and a plurality of models running in parallel, the plurality of models (e.g., a CNN model 2422 (e.g., a CNN model processing FMV data), an RNN model 2423 (e.g., an RNN model processing PAI (personal activity intelligence) data), a LSTM model 2424 (e.g., a LTSM model processing WAMI (wide-area motion imagery) data), etc.), an AIP 2422A receiving AI model results and interfacing with a downstream model, a georegistration model 2425 with corresponding AIP 2425A also interfacing downstream models, a correlation model (e.g., a fusion model) 2426, an AIP 2426A, and a multi-INT reasoning model 2427.

In some embodiments, the multi-INT reasoning model 2427 can generate a qualitative and/or quantitate reasoning. In certain embodiments, using a model pipeline (e.g., AI pipelines and parallelism), the AIP service 2420 manages multiple models 2422, 2423, 2424, 2425, 2426, 2427 running against its data (e.g., AI-ready data), either in parallel or sequence. In some embodiments, at least two of the AIPs 2421A, 2422A, 2425A, 2426A can be a same AIP. In certain embodiments, the AIPs 2421A, 2422A, 2425A, 2426A can include two or different AIPs.

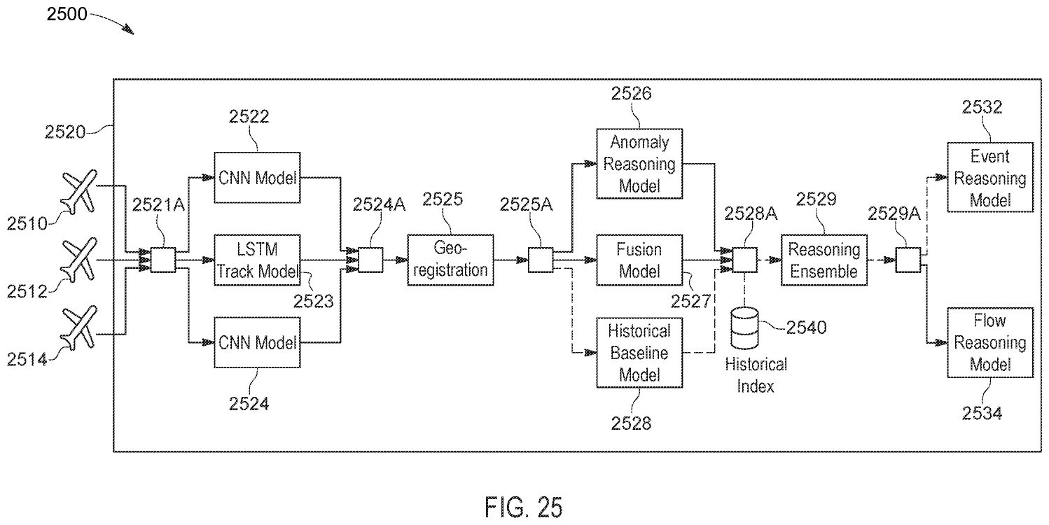

FIG. 25 is an example AIP system 2500 for a use case (e.g., machine reasoning, real-time machine reasoning) according to certain embodiments of the present disclosure. FIG. 25 is merely an example. One of ordinary skill in the art would recognize many variations, alternatives, and modifications. In some embodiments, the AIP system 2500 includes one or more edge devices 2510, 2512, 2514, and an AIP service 2520. In certain embodiments, the AIP service 2520 includes an AIP 2521A interfacing with the edge devices and a plurality of models running in parallel, the plurality of models (e.g., a CNN model 2522 (e.g., a CNN model processing SI (security intelligence) data), a LSTM model 2523 (e.g., a LTSM model processing WAMI data), a CNN model 2524 (e.g., a CNN model processing FMV data), etc.), an AIP 2524A receiving AI model results and interfacing with a downstream model, a georegistration model 2525 with corresponding AIP 2525A also interfacing downstream models, the downstream models including one or more models running in parallel (e.g., an anomaly reasoning model 2526, a fusion model 2527, a historical baseline model 2528, etc.), an AIP 2528A interfacing with the one or more upstream models, a reasoning ensemble model 2529, an AIP 2529A interfacing with one or more downstream models, and the downstream models including an event reasoning model 2532 and a flow reasoning model 2534.

In some embodiments, the reasoning ensemble 2529 can combine model outputs and historical index data 2540. In certain embodiments, using a model pipeline (e.g., AI pipelines and parallelism), the AIP service 2520 manages multiple models 2522, 2523, 2524, 2525, 2526, 2527, 2528, 2529, 2532, 2534 running against its data (e.g., AI-ready data), either in parallel or sequence. In some embodiments, at least two of the AIPs 2521A, 2524A, 2525A, 2528A, 2529A can be a same AIP. In certain embodiments, the AIPs 22521A, 2524A, 2525A, 2528A, 2529A can include two or different AIPs.

In some examples, for rich model outputs, one or more models provide the orchestrator's inference interface with rich output data, including multiclass confidence scores and/or layer activations. For example, these are used by one or more downstream models (e.g., higher-order models, ensemble agent, fusion model, reasoning model). In certain examples, for AI pipeline introspection, the orchestrator allows one or more modelers to probe the intermediate layers for a model, or the output it passes down in a pipeline. For example, this data can be used by one or more modelers to debug and tune their models, and/or provide one or more decision-makers explanations for operational AI insights.

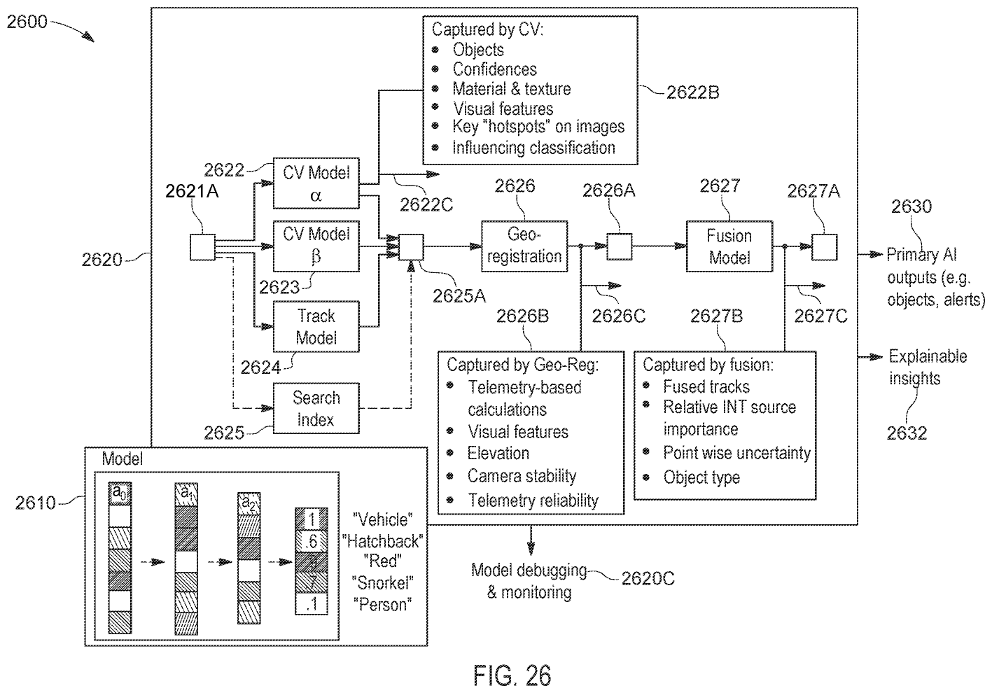

FIG. 26 is an example AIP system 2600 for a use case (e.g., AI microservices mesh related to AI Inference Platform) according to certain embodiments of the present disclosure. FIG. 26 is merely an example. One of ordinary skill in the art would recognize many variations, alternatives, and modifications. In some embodiments, the AIP system 2600 includes one or more models 2610 and an AIP service 2620, including an AIP 2621A, a plurality of models running in parallel (e.g., CV model α 2622, CV model β 2623, track model 2624, search index 2625, etc.), an AIP 2625A interfaces the plurality of upstream models, a debugging output 2522C, and a plurality of models running in sequence (e.g., a georegistration model 2626, a fusion model 2627, etc.), debug outputs 2626C and 2627C, a primary AI outputs (e.g., objects, alerts, etc.) 2630, and one or more explainable insights 2632. In certain embodiments, using a model pipeline (e.g., AI pipelines and parallelism), the AIP service 2620 manages multiple models 2622, 2623, 2624, 2626, 2627 running against respective data (e.g., AI-ready data), either in parallel or sequence. In some embodiments, at least two of the AIPs 2621A, 2625A, 2626A, 2627A can be a same AIP. In certain embodiments, the AIPs 2621A, 2625A, 2626A, 2627A can include two or different AIPs.

In some embodiments, a CV model can generate data 2622B including, for example, one or more recognized objects and associated confidences, identified material and texture, identified visual features, hotspots in images (e.g., key hotspots), influencing classification, and/or the like.

In certain embodiments, the georegistration model 2626 can generate data 2626B including, for example, one or more telemetry-based calculations, one or more visual features, elevation, camera stability, telemetry reliability, and/or the like. In some embodiments, the fusion model 2627 can generate, for example, one or more fused tracks, relative intelligence source importance, point-wise uncertainty, object type, and/or the like. In certain examples, for real-time and/or asynchronous models, one or more model services subscribe to real-time data feeds and run within configurable time constraints. As an example, one or more models (e.g., search) run asynchronously based on one or more user or algorithmic triggers. In certain examples, for scalable AI microservices, one or more orchestration and model microservices (e.g., each a targeted service) are dynamically scaled up and down as mission requirements and datasets evolve. For example, deploying one or more new models does not affect one or more existing services. In some examples, for cloud-ready and/or edge-ready AI containers, one or more model microservices can be bundled flexibly to optimally use cloud and edge computing resources, managed by the orchestrator.

In certain examples, for ontology adjectives, one or more ontology classes include dynamic and/or descriptive properties associated with each detection, rather than static types. In some examples, for multiple classes per detection, one or more detections have multiple AI-detected properties, helping users characterize their targets in increasing detail. In certain examples, for accumulation along tracks, one or more tracked entities accumulate one or more AI-properties over time, giving users probability information for each characteristic and changes. In some examples, for ontology for higher-order AI, when one or more detection algorithms output their full findings, one or more downstream models (e.g., ensemble agents, reasoning models) achieve superior results. In certain examples, for rapid prototyping and/or fielding, one or more properties added by new models do not adversely affect one or more existing properties, accelerating new AI fielding against one or more emergent mission needs.

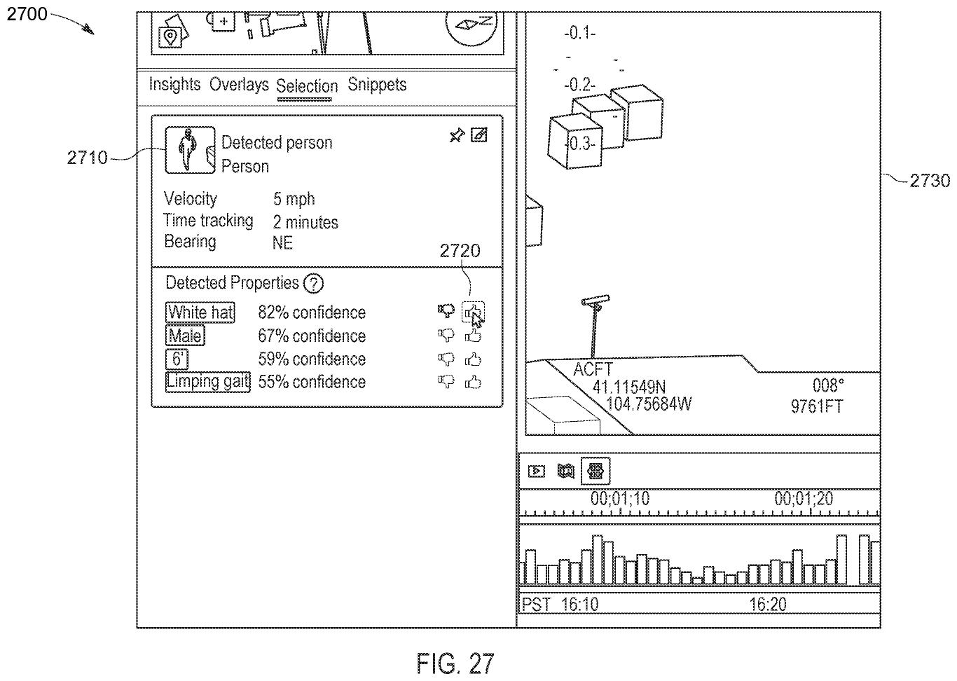

FIG. 27 is an illustrative graphical user interface (GUI) 2700 for an AIP system according to certain embodiments of the present disclosure. FIG. 27 is merely an example. One of ordinary skill in the art would recognize many variations, alternatives, and modifications. In some embodiments, the GUI 2700 includes a representation of a target object 2710, one or more user controls 2720, and a representation of captured sensor data 2730. In certain embodiments, the AIP system uses one or more AIPs and associated AI models to process the captured sensor data and identify the target object 2710. In some embodiments, the AIP system allows user feedback to be received via the one or more user controls 2720.

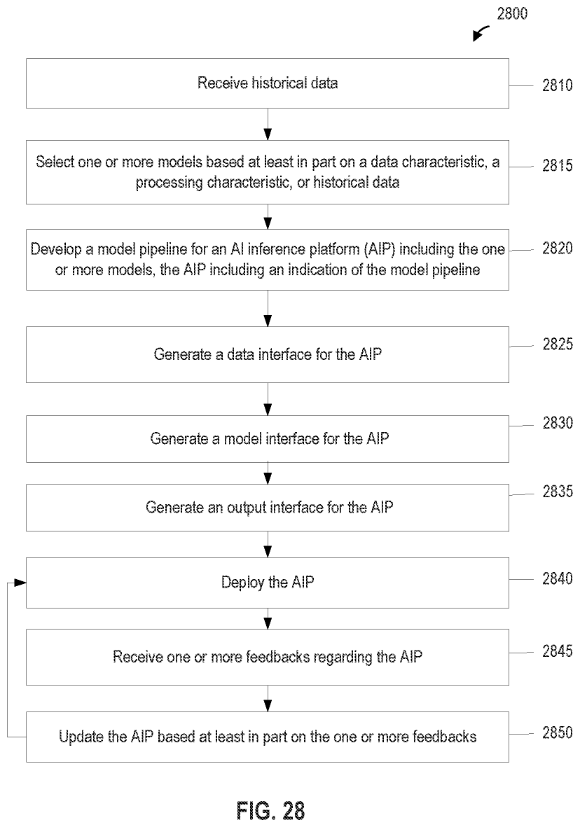

FIG. 28 is a simplified diagram showing a method 2800 for AIP development according to certain embodiments of the present disclosure. This diagram is merely an example. One of ordinary skill in the art would recognize many variations, alternatives, and modifications. The method 2800 for AIP development includes processes 2810, 2815, 2820, 2825, 2830, 2835, 2840, 2845, and 2850. Although the above has been shown using a selected group of processes for the method 2800 for AIP development, there can be many alternatives, modifications, and variations. For example, some of the processes may be expanded and/or combined. Other processes may be inserted to those noted above. Depending upon the embodiment, the sequence of processes may be interchanged with others replaced. Further details of these processes are found throughout the present disclosure.

According to some embodiments, at the process 2810, an AIP system (e.g., the AIP system 400 in FIG. 4, the AIP system 1100 in FIG. 11) receives historical data (e.g., sensor data, ensembled data, processed data, model results, insights, etc.). In certain embodiments, at the process 2815, the AIP system selects one or more models based at least in part on a data characteristic, a processing characteristic, and historical data. In certain examples, the processing characteristic may include a type of data processing (e.g., a video frame extraction, an image processing, an object recognition, a decoding, an encoding), a requirement of data processing, and other data processing characteristic. In some examples, the data characteristic may include an input data type, an input data format, an input data volume, an input data range, an output data type, an output data format, and/or the like.

According to certain embodiments, at the process 2820, the AIP system develops a model pipeline for an AI interference platform (AIP) including the one or more models, the AIP including an indication of the model pipeline. In some embodiments, the model pipeline is generated based at least in part on the data characteristic, the processing characteristic, and the historical data. In certain embodiments, the model pipeline includes a computer-vision model being an upstream model of a georegistration model. In some embodiments, the AIP includes an indication of a model pipeline including two or more models running in sequence. In certain embodiments, the model pipeline includes a first model being an upstream model of a second model, where a model result of the first model is fed into the second model. In certain embodiments, the model result of the first model is received by the AIP and output to the second model via an API. In some embodiments, the first model (e.g., a track model) is different from the second model (e.g., a reasoning model).

In certain embodiments, the model pipeline includes three models running in sequence. In some examples, a first model is an upstream model of a second model and the second model is an upstream model of a third model, where a model result of the first model is fed into the second model and a model result of the second model is fed into the third model. In certain embodiments, the model result of the first model is received by the AIP and output to the second model via an API. In certain embodiments, the model result of the second model is received by the AIP and output to the third model via an API. In some embodiments, the three models are different from each other.

In some embodiments, the AIP includes an indication of a model pipeline including two or more models running in parallel. In certain embodiments, the model pipeline includes a first model running in parallel with a second model, where a model result of the first model and a model result of the second model are generated based on same input or different parts of the same input. In some embodiments, the first model (e.g., a track model) is different from the second model (e.g., a reasoning model).

In certain embodiments, the model pipeline includes three models running in parallel. In some examples, a first model, a second model and a third model are running in parallel, where a model result of the first model, a model result of the second model, and a model result of the third model are generated based on same input or different parts of the same input. In certain embodiments, the model results are received by the AIP. In some embodiments, the model results are received by the AIP via APIs. In some embodiments, the three models are different from each other.

In some embodiments, the AIP includes an indication of a model pipeline including one or more first models running in sequence with a set of second models running in parallel. In certain examples, the model pipeline includes a first model (e.g., an ensemble agent) being an upstream model of a set of second models running in parallel, where a model result of the first model is fed into the set of second models. In certain embodiments, the model result of the first model is received by the AIP and output to the set of second models via one or more APIs.

According to certain embodiments, at the process 2825, the AIP system generates a data interface for the AIP. In some embodiments, the data interface includes one or more APIs. In certain embodiments, the data interface can accept sensor data. In some embodiments, at the process 2830, the AIP system generates a model interface for the AIP. In certain embodiments, the model interface can provide data to the model pipeline and receive model results from the model pipeline. In some embodiments, the model interface uses one or more APIs defined by one or more corresponding models. In some embodiments, at the process 2835, the AIP system generates an output interface for the AIP. In certain embodiments, the output interface can provide outputs (e.g., insights) to a user device.

According to some embodiments, at the process 2840, the AIP system deploys the AIP, for example, via pushing to one or more edge devices or published to make the AIP available. In certain embodiments, at the process 2845, the AIP system receives one or more feedbacks regarding the AIP and associated model pipeline. In some embodiments, the one or more feedbacks include an input from a user, a system input, one or more model outputs generated by a deployed AIP, and/or the like. In certain embodiments, at the process 2850, the AIP system updates the AIP based at least in part on the one or more feedbacks. In some embodiments, the model pipeline is updated based at least in part on the feedbacks. In certain embodiments, at least one of the one or more models in the model pipeline is changed or deleted. In some embodiments, one or more models are added to the model pipeline. In certain embodiments, at least one of the data interface, the model interface, and the output interface is updated. In certain embodiments, the AIP system goes back to the process 2840 to deploy the updated AIP.

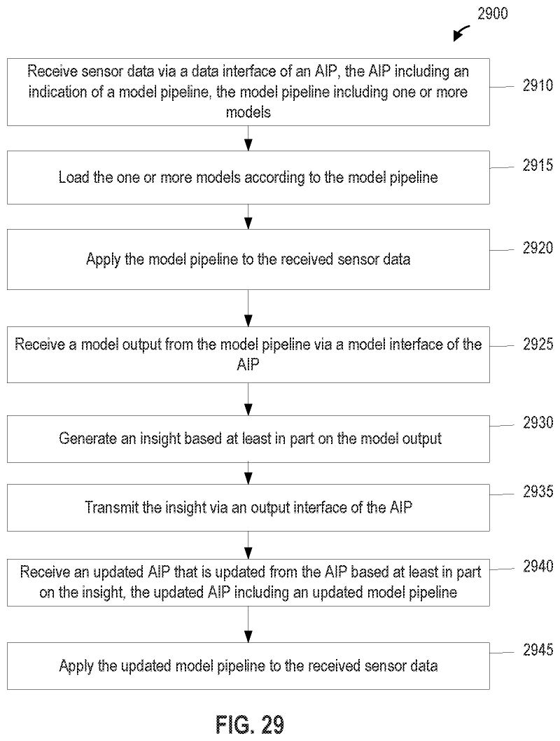

FIG. 29 is a simplified diagram showing a method 2900 for AIP use according to certain embodiments of the present disclosure. This diagram is merely an example. One of ordinary skill in the art would recognize many variations, alternatives, and modifications. The method 2900 for AIP development includes processes 2910, 2915, 2920, 2925, 2930, 2935, 2940, and 2945. Although the above has been shown using a selected group of processes for the method 2900 for AIP development, there can be many alternatives, modifications, and variations. For example, some of the processes may be expanded and/or combined. Other processes may be inserted to those noted above. Depending upon the embodiment, the sequence of processes may be interchanged with others replaced. Further details of these processes are found throughout the present disclosure.

According to some embodiments, at the process 2910, an AIP system (e.g., the AIP system 1100 in FIG. 11, the AIP system 1800 in FIG. 18) receives sensor data via a data interface of an AIP, the AIP including an indication of a model pipeline, the model pipeline including one or more models. In certain embodiments, the model pipeline includes at least two models running in sequence and/or at least two models running parallel. In certain embodiments, at the process 2915, the AIP system loads the one or more models according to the model pipeline.

According to certain embodiments, at the process 2920, the AIP system applies the model pipeline to the received sensor data. In certain embodiments, the model pipeline includes a computer-vision model being an upstream model of a georegistration model. In some embodiments, the AIP includes an indication of a model pipeline including two or more models running in sequence. In certain embodiments, the model pipeline includes a first model being an upstream model of a second model, where a model result of the first model is fed into the second model. In certain embodiments, the model result of the first model is received by the AIP and output to the second model via an API. In some embodiments, the first model (e.g., a track model) is different from the second model (e.g., a reasoning model).

In certain embodiments, the model pipeline includes three models running in sequence. In some examples, a first model is an upstream model of a second model and the second model is an upstream model of a third model, where a model result of the first model is fed into the second model and a model result of the second model is fed into the third model. In certain embodiments, the model result of the first model is received by the AIP and output to the second model via an API. In certain embodiments, the model result of the second model is received by the AIP and output to the third model via an API. In some embodiments, the three models are different from each other.

In some embodiments, the AIP includes an indication of a model pipeline including two or more models running in parallel. In certain embodiments, the model pipeline includes a first model running in parallel with a second model, where a model result of the first model and a model result of the second model are generated based on same input or different parts of the same input. In some embodiments, the first model (e.g., a track model) is different from the second model (e.g., a reasoning model).

In certain embodiments, the model pipeline includes three models running in parallel. In some examples, a first model, a second model and a third model are running in parallel, where a model result of the first model, a model result of the second model, and a model result of the third model are generated based on same input or different parts of the same input. In certain embodiments, the model results are received by the AIP. In some embodiments, the model results are received by the AIP via APIs. In some embodiments, the three models are different from each other.

In some embodiments, the AIP includes an indication of a model pipeline including one or more first models running in sequence with a set of second models running in parallel. In certain examples, the model pipeline includes a first model (e.g., an ensemble agent) being an upstream model of a set of second models running in parallel, where a model result of the first model is fed into the set of second models. In certain embodiments, the model result of the first model is received by the AIP and output to the set of second models via one or more APIs.

According to certain embodiments, at the process 2925, the AIP receives a model output from the model pipeline via a model interface of the AIP. In some embodiments, the model output is generated via the one or more models in the model pipeline running sequentially and/or in parallel. In certain embodiments, the model output is a combination of model outputs of the one or more models in the model pipeline running sequentially and/or in parallel. In some embodiments, the model output is an output of an upstream model (e.g., a fusion model, a reasoning model, etc.) in the model pipeline. In certain embodiments, at the process 2930, the AIP generates an insight based at least in part on the model output. In some embodiments, the insight can have a data size smaller than the received sensor data. In certain embodiments, the insight includes a decision (e.g., an object recognition, a description of the recognized object) generated by the model pipeline. In some embodiments, at the process 2935 the AIP transmits the insight via an output interface of the AIP. In certain embodiments, the output interface can provide outputs (e.g., insights) to a user device.

According to some embodiments, at the process 2940, the AIP system receives an updated AIP that is updated from the AIP based at least in part on the insight, the updated AIP including an updated model pipeline that is updated from the model pipeline. In certain embodiments, at least one of the one or more models in the model pipeline is changed or deleted. In some embodiments, one or more models are added to the model pipeline. In certain embodiments, at least one of the data interface, the model interface, and the output interface is updated. In some embodiments, at the process 2945, the AIP applies the updated model pipeline to the received sensor data.

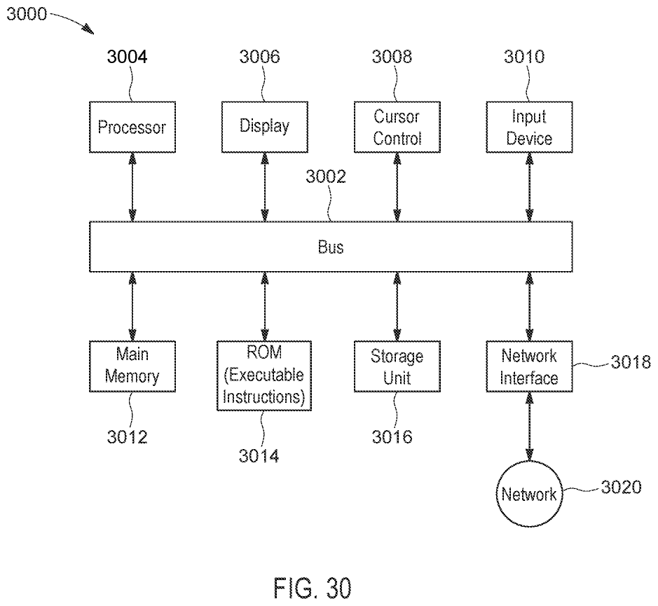

FIG. 30 is a simplified diagram showing a computing system for implementing a system for AIP according to one embodiment of the present disclosure. This diagram is merely an example, which should not unduly limit the scope of the claims. One of ordinary skill in the art would recognize many variations, alternatives, and modifications. The computing system 3000 includes a bus 3002 or other communication mechanism for communicating information, a processor 3004, a display 3006, a cursor control component 3008, an input device 3010, a main memory 3012, a read only memory (ROM) 3014, a storage unit 3016, and a network interface 3018. In some embodiments, some or all processes (e.g., steps) of the method 2800 and/or the method 2900 are performed by the computing system 3000. In some examples, the bus 3002 is coupled to the processor 3004, the display 3006, the cursor control component 3008, the input device 3010, the main memory 3012, the read only memory (ROM) 3014, the storage unit 3016, and/or the network interface 3018. In certain examples, the network interface is coupled to a network 3020. For example, the processor 3004 includes one or more general purpose microprocessors. In some examples, the main memory 3012 (e.g., random access memory (RAM), cache and/or other dynamic storage devices) is configured to store information and instructions to be executed by the processor 3004. In certain examples, the main memory 3012 is configured to store temporary variables or other intermediate information during execution of instructions to be executed by processor 3004. For examples, the instructions, when stored in the storage unit 30130 accessible to processor 3004, render the computing system 3000 into a special-purpose machine that is customized to perform the operations specified in the instructions. In some examples, the ROM 3014 is configured to store static information and instructions for the processor 3004. In certain examples, the storage unit 3016 (e.g., a magnetic disk, optical disk, or flash drive) is configured to store information and instructions.

In some embodiments, the display 3006 (e.g., a cathode ray tube (CRT), an LCD display, or a touch screen) is configured to display information to a user of the computing system 3000. In some examples, the input device 3010 (e.g., alphanumeric and other keys) is configured to communicate information and commands to the processor 3004. For example, the cursor control 3008 (e.g., a mouse, a trackball, or cursor direction keys) is configured to communicate additional information and commands (e.g., to control cursor movements on the display 3006) to the processor 3004.

According to certain embodiments, a method for using one or more model orchestrators, the method includes the steps of: receiving sensor data via a data interface of one model orchestrator of the one or more model orchestrators, the one model orchestrator including an indication of a model pipeline, the model pipeline including a plurality of models; loading the plurality of models according to the model pipeline; applying the model pipeline to the received sensor data; receiving a model output from the model pipeline via a model interface of the one model orchestrator; and generating an insight based at least in part on the model output, the insight is smaller than the sensor data in data size; wherein the method is performed using one or more processors. For example, the method is implemented according to at least FIG. 1, FIG. 2, FIG. 3, FIG. 28 and/or FIG. 29.

In some embodiments, the model pipeline includes a first model and a second model running in sequence, where a model output of the first model is an input to the second model. In certain embodiments, the model pipeline includes a first model and a second model running in parallel, where the sensor data is an input to the first model and an input to the second model. In some embodiments, the model pipeline further includes a third model receiving a model output of the first model and a model output of the second model. In certain embodiments, the data interface includes a first data interface for receiving first sensor data collected by a first edge device and a second data interface for receiving second sensor data collected by a second edge device. In some embodiments, the method further includes transmitting the insight to a computing device via an output interface of the one model orchestrator. In certain embodiments, the method further includes receiving an updated model orchestrator that is updated from the one model orchestrator based at least in part on the insight, the updated model orchestrator including an updated model pipeline; and applying the updated model pipeline to the received sensor data.

According to certain embodiments, a method for managing one or more model orchestrators, the method includes the steps of: receiving historical data; selecting one or more models based at least in part on a data characteristic, a processing characteristic, or the historical data; developing a model pipeline including the one or more models, the model orchestrators including an indication of the model pipeline; generate a data interface for one model orchestrator of the one or more model orchestrators to interface with real-time sensor data; generate a model interface for the model orchestrators to interface with the model pipeline; and deploy the one model orchestrator; wherein the method is performed using one or more processors. For example, the method is implemented according to at least FIG. 1, FIG. 2, FIG. 3, FIG. 28 and/or FIG. 29.

In some embodiments, the model pipeline includes a first model and a second model running in sequence, where a model output of the first model is an input to the second model. In certain embodiments, the model pipeline includes a first model and a second model running in parallel, where the sensor data is an input to the first model and an input to the second model. In some embodiments, the model pipeline further includes a third model receiving a model output of the first model and a model output of the second model. In certain embodiments, the data interface includes a first data interface for receiving first sensor data collected by a first edge device and a second data interface for receiving second sensor data collected by a second edge device. In some embodiments, the method further includes generating an output interface for the one model orchestrator to interface a computing device. In certain embodiments, the method further includes receiving one or more feedbacks regarding the one model orchestrator; and updating the one model orchestrator based at least in part on the one or more feedbacks.

According to certain embodiments, a system for using one or more model orchestrators, the system comprising: one or more memories comprising instructions stored thereon; and one or more processors configured to execute the instructions and perform operations comprising: receiving sensor data via a data interface of one model orchestrator of the one or more model orchestrators, the one model orchestrator including an indication of a model pipeline, the model pipeline including a plurality of models; loading the plurality of models according to the model pipeline; applying the model pipeline to the received sensor data; receiving a model output from the model pipeline via a model interface of the one model orchestrator; and generating an insight based at least in part on the model output, the insight is smaller than the sensor data in data size. For example, the system is implemented according to at least FIG. 1, FIG. 2, FIG. 3, FIG. 28 and/or FIG. 29.

In some embodiments, the model pipeline includes a first model and a second model running in sequence, where a model output of the first model is an input to the second model. In certain embodiments, the model pipeline includes a first model and a second model running in parallel, where the sensor data is an input to the first model and an input to the second model. In some embodiments, the model pipeline further includes a third model receiving a model output of the first model and a model output of the second model. In certain embodiments, the data interface includes a first data interface for receiving first sensor data collected by a first edge device and a second data interface for receiving second sensor data collected by a second edge device. In some embodiments, the operations further comprise: receiving an updated model orchestrator that is updated from the one model orchestrator based at least in part on the insight, the updated model orchestrator including an updated model pipeline; and applying the updated model pipeline to the received sensor data.

For example, some or all components of various embodiments of the present disclosure each are, individually and/or in combination with at least another component, implemented using one or more software components, one or more hardware components, and/or one or more combinations of software and hardware components. In another example, some or all components of various embodiments of the present disclosure each are, individually and/or in combination with at least another component, implemented in one or more circuits, such as one or more analog circuits and/or one or more digital circuits. In yet another example, while the embodiments described above refer to particular features, the scope of the present disclosure also includes embodiments having different combinations of features and embodiments that do not include all of the described features. In yet another example, various embodiments and/or examples of the present disclosure can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, EEPROM, Flash memory, flat files, databases, programming data structures, programming variables, IF-THEN (or similar type) statement constructs, application programming interface, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, DVD, etc.) that contain instructions (e.g., software) for use in execution by a processor to perform the methods' operations and implement the systems described herein. The computer components, software modules, functions, data stores and data structures described herein may be connected directly or indirectly to each other in order to allow the flow of data needed for their operations. It is also noted that a module or processor includes a unit of code that performs a software operation and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present disclosure have been described, it will be understood by those of skill in the art that there are other embodiments that are equivalent to the described embodiments. Accordingly, it is to be understood that the invention is not to be limited by the specific illustrated embodiments.

What is claimed is:

1. A method for using one or more model orchestrators, the method comprising:
receiving sensor data via a data interface of one model orchestrator of the one or more model orchestrators, the one model orchestrator including an indication of a model pipeline, the model pipeline including a plurality of models;
loading the plurality of models according to the model pipeline;
applying the model pipeline to the received sensor data;
receiving a model output from the model pipeline via a model interface of the one model orchestrator; and
generating an insight based at least in part on the model output, the insight is smaller than the sensor data in data size;
wherein the method is performed using one or more processors.

2. The method of claim 1, wherein the model pipeline includes a first model and a second model running in sequence, wherein a model output of the first model is an input to the second model.

3. The method of claim 1, wherein the model pipeline includes a first model and a second model running in parallel, wherein the sensor data is an input to the first model and an input to the second model.

4. The method of claim 3, wherein the model pipeline further includes a third model receiving a model output of the first model and a model output of the second model.

5. The method of claim 1, wherein the data interface includes a first data interface for receiving first sensor data collected by a first edge device and a second data interface for receiving second sensor data collected by a second edge device.

6. The method of claim 1, further comprising:
transmitting the insight to a computing device via an output interface of the one model orchestrator.

7. The method of claim 1, further comprising:
receiving an updated model orchestrator that is updated from the one model orchestrator based at least in part on the insight, the updated model orchestrator including an updated model pipeline; and
applying the updated model pipeline to the received sensor data.

8. A method for managing one or more model orchestrators, the method comprising:
receiving historical data;
selecting one or more models based at least in part on a data characteristic, a processing characteristic, or the historical data;
developing a model pipeline including the one or more models, one model orchestrator of one or more model orchestrators including an indication of the model pipeline;
generate a data interface for the one model orchestrator to interface with real-time sensor data;
generate a model interface for the one model orchestrator to interface with the model pipeline; and
deploy the one model orchestrator;
wherein the method is performed using one or more processors.

9. The method of claim 8, wherein the model pipeline includes a first model and a second model running in sequence, wherein a model output of the first model is an input to the second model.

10. The method of claim 8, wherein the model pipeline includes a first model and a second model running in parallel, wherein the sensor data is an input to the first model and an input to the second model.

11. The method of claim 10, wherein the model pipeline further includes a third model receiving a model output of the first model and a model output of the second model.

12. The method of claim 8, wherein the data interface includes a first data interface for receiving first sensor data collected by a first edge device and a second data interface for receiving second sensor data collected by a second edge device.

13. The method of claim 1, further comprising:
generating an output interface for the one model orchestrator to interface a computing device.

14. The method of claim 1, further comprising:
receiving one or more feedbacks regarding the one model orchestrator; and
updating the one model orchestrator based at least in part on the one or more feedbacks.

15. A system for using one or more model orchestrators, the system comprising:
one or more memories comprising instructions stored thereon; and
one or more processors configured to execute the instructions and perform operations comprising:
receiving sensor data via a data interface of one model orchestrator of the one or more model orchestrators, the one model orchestrator including an indication of a model pipeline, the model pipeline including a plurality of models;
loading the plurality of models according to the model pipeline;
applying the model pipeline to the received sensor data;
receiving a model output from the model pipeline via a model interface of the one model orchestrator; and
generating an insight based at least in part on the model output, the insight is smaller than the sensor data in data size.

16. The system of claim 15, wherein the model pipeline includes a first model and a second model running in sequence, wherein a model output of the first model is an input to the second model.

17. The system of claim 15, wherein the model pipeline includes a first model and a second model running in parallel, wherein the sensor data is an input to the first model and an input to the second model.

18. The system of claim 17, wherein the model pipeline further includes a third model receiving a model output of the first model and a model output of the second model.

19. The system of claim 15, wherein the data interface includes a first data interface for receiving first sensor data collected by a first edge device and a second data interface for receiving second sensor data collected by a second edge device.

20. The system of claim 15, wherein the operations further comprise:
receiving an updated model orchestrator that is updated from the one model orchestrator based at least in part on the insight, the updated AIP including an updated model pipeline; and
applying the updated model pipeline to the received sensor data.
